(19) United States
(12) Patent Application Publication
(10) Pub. No.: US 2016/0251470 A1
(43) Pub. Date: Sep. 1, 2016

(54) ZWITTERIONIC POLYSACCHARIDE POLYMERS HAVING ANTIFOULING, ANTIMICROBIAL AND OPTICAL TRANSPARENCY PROPERTIES

(71) Applicant: THE UNIVERSITY OF AKRON, AKRON, OH (US)

(72) Inventors: Gang Cheng, Fairlawn, OH (US); Bin Cao, Akron, OH (US)

(21) Appl. No.: 15/028,788

(22) PCT Filed: Oct. 14, 2014
(86) PCT No.: PCT/US2014/060397

§ 371 Date: Apr. 12, 2016

Related U.S. Application Data
(60) Provisional application No. 61/890,515, filed on Oct. 14, 2013.

(51) Int. Cl. C08F 290/10; C08B 37/02

(52) U.S. Cl. CPC C08F 290/10; C08B 37/0021

(57) ABSTRACT

The present invention is directed to facile method of zwitteration of polysaccharides or other polymers with carboxybetaine (CB) or another zwitterionic betaine. Zwitterionic CB functional groups were seamlessly integrated onto dextran backbone via a one pot reaction. Different degrees of substitution were achieved by repeating the reaction and controlling the ratio of reactants. CB side groups in CB-functionalized dextran (CB-Dex) can switch between cationic and zwitterionic forms under acidic and neutral conditions. The ring structure formation was confirmed by heteronuclear multiple-bond correlation (gHMBC) 2D-NMRAntifouling properties of CB-Dex were tested in the form of hydrogel using a fluorescent method. The amount of adsorbed protein decreases dramatically with the increase of CB content. For the cell attachment study, there was almost no cell attaching on the CB-Dex hydrogel surface with the higher CB content. In addition, the optical transparency of hydrogel was enhanced significantly by increasing the CB content.

### CROSS REFERENCE TO RELATED APPLICATIONS

This application claims the benefit of U.S. provisional patent application Ser. No. 61/890,515 entitled “Zwitteration of Dextran: A Facile Route to Integrate Antifouling, Switchability and Optical Transparency into Natural Polymers,” filed Oct. 14, 2013, which are incorporated herein by reference in their entirety.

### REFERENCE TO GOVERNMENT SUPPORT

The invention was developed at least in part with the support of U.S. National Science Foundation grant number NSF CMMI-1129727. The government may have certain rights in the invention.

### FIELD OF THE INVENTION

One or more embodiments of the present invention relates to switchable antimicrobial and antifouling materials and coatings for use in various biomedical applications. In certain embodiments, one or more embodiments of the present invention relate to switchable antimicrobial and antifouling carboxybetaine-based hydrogels with enhanced mechanical properties.

### BACKGROUND OF THE INVENTION

Recently, there has been increasing interests in antifouling materials for use in various biomedical applications. Fouling is an undesired process in which molecules and/or living organisms from environment attach and accumulate onto a surface. The undesired surface adsorption of biomacromolecules for example, can cause the failure of biomedical devices. Thus, materials with superior antifouling properties have been urgently sought.

In recent years, zwitterionic materials, especially carboxybetaine (CB)-based materials, have attracted great attention due to their outstanding antifouling properties, as well as the capability of further functionalization for biosensing and drug delivery. These materials have been proven to effectively reduce bacterial attachment, biofilm formation, and highly resist nonspecific protein adsorption even from undiluted blood plasma.

These zwitterionic coatings can reduce initial attachment and delay biofilm formation on surfaces, but they are not able to kill attached microorganisms. Pathogenic microbes are sometimes introduced into the patient during implantation operations and catheter insertions, causing the failure of implanted devices. Antimicrobial agents are necessary to eliminate these microbes. Surface-responsive materials with antimicrobial properties have been developed for a broad spectrum of applications, but there has been a need for materials and coatings having both antimicrobial and antifouling/biocompatibility capabilities.

Polysaccharides are most abundant and most commonly used natural polymers, which have been used in many biotech and biomedical applications, including coatings, biosensing, tissue engineering, drug delivery, and bioseparation/purification. Polysaccharide-based materials have attracted a great attention due to their ability of resisting proteins, mammalian cells and microbes, biocompatibility, biodegradability, capability of further functionalization for biosensing and drug delivery, as well as design flexibility for a broad range of applications.

Despite intense interests in polysaccharide materials, there are several challenges to be addressed to let the potential of polysaccharide materials fully realized in biotech and biomedical applications. Firstly, antifouling properties of natural polysaccharides are unsatisfactory in applications dealing with the complex medium. For example, antifouling surface from dextran-derivatives in biosensing is not effective in resisting protein fouling from blood sample. Agarose-based affinity protein purification system is troubled by non-specific protein adsorption. Secondly, natural polysaccharides do not carry both antifouling property and functionality to conjugate other moieties (such as capture ligand and cell adhesion molecule), which are needed in affinity bioseparation, biosensing, tissue engineering and drug delivery. In most cases, functional groups such as tetrazole and carboxylate groups have to be incorporated into polysaccharides. Excessive unreacted functional groups cause non-specific protein adsorption, thus either reducing the sensitivity of the biosensor or leading to low purity in bioseparation. Thirdly, natural polysaccharides can resist bacterial attachment but cannot kill a small amount of attached microbes. Microorganisms can be introduced into patients during surgical procedures, and colonized microorganisms on the surface of the implanted material/device will trigger inflammation and immune response.

Therefore, there is a need in the art for a polysaccharide polymer material integrating the desired properties including excellent antifouling property to prolong the lifetime of implanted materials, antimicrobial property to eliminate surgical infection and chronic inflammation, and functionality for conjugating bioactive moieties to promote tissue integration, without the limitations present in the prior art.

### SUMMARY OF THE INVENTION

In general outline, the present invention is directed to a versatile and high performance zwitterionic polysaccharide platform for various biotech and biomedical applications that addresses the deficiencies found in existing polysaccharide materials. Embodiments of the present invention depart from the conventional approach of blending of polysaccharide with other functional materials by integrating all required functions (e.g. enhanced antifouling, biocompatibility, functionality for further modification, sensitivity to environmental stimuli and antimicrobial properties) into one polymer chain. The integrated zwitterionic polysaccharides of various embodiments of the present invention consist of a polysaccharide backbone and multifunctional zwitterionic side chains. These polysaccharides can obtain excellent biocompatibility, sensitivity to environmental stimuli, functional groups for bioconjugation and antimicrobial property via multifunctional zwitterionic side chains, while zwitterionic materials can obtain biodegradability from the polysaccharide backbone.

In a first aspect, the present invention provides a zwitterionic composition having excellent anti-fouling, switchability, antimicrobial and optical properties comprising: a polymer backbone and one or more zwitterionic moieties chemically bonded to said polymer backbone wherein the zwitterionic moieties further comprising a carboxybetaine group. In some embodiments, the zwitterionic moieties have at least one ethanol, propanol, butanol or pentanol group bonded to the nitrogen atom of said carboxybetaine group. In some embodiments, the polymer backbone comprises a polysaccharide polymer backbone. In one or more embodiments, the zwitterionic composition may include, without limitation, any one or more embodiments of the first aspect of the present invention wherein the degree of substitution of one or more zwitterionic moieties comprise from 1% to 300%. In one or more embodiments, the zwitterionic composition may include any one or more embodiments of the first aspect of the present invention wherein the weight average molecular weight of the zwitterionic composition is from 300 to 10,000,000 daltons.

In one or more embodiments, the zwitterionic composition may include any one or more embodiments of the first aspect of the present invention wherein the polymer backbone comprises a (poly(vinyl alcohol), poly(2-hydroxyethyl methacrylate), poly(2-hydroxyethyl acrylate), poly(3-hydroxypropyl methacrylate), poly(3-hydroxypropyl acrylate), poly(4-hydroxybutyl methacrylate), poly(5-hydroxypentyl acrylate), poly(5-hydroxypentyl methacrylate), poly(4-hydroxybutyl acrylate), poly(N(2-hydroxyethyl) methacrylamide), poly(N-(3-hydroxypropyl) methacrylamide), poly(N-(4-hydroxybutyl) methacrylamide), poly(N-(5-hydroxypentyl) methacrylamide), poly(N-(2-hydroxyethyl)acrylamide), poly(N-(3-hydroxypropyl) acrylamide), poly(N-(4-hydroxybutyl) acrylamide), poly(N-(5-hydroxypentyl) acrylamide), polyserine, poly lysine, polyamine, polyphenol, poly(1-glycerol methacrylate), poly(2,3-dihydrothieno[3,4-b][1,4]dioxin-2-yl) methanol), poly(2-(2,3-dihydrothieno[3,4-b][1,4]dioxin-2-yl) ethan-1-ol), poly(3-(2,3-dihydrothieno[3,4-b][1,4]dioxin-2-yl) propan-1-ol), poly(1-(2,3-dihydrothieno[3,4-b][1,4]dioxin-2-yl) propan-2-ol), poly(3-(2,3-dihydrothieno[3,4-b][1,4]dioxin-2-yl) propane-1,2-diol), poly(4-(2,3-dihydrothieno[3,4-b][1,4]dioxin-2-yl)butan-1-ol), poly(5-(2,3-dihydrothieno[3,4-b][1,4]dioxin-2-yl)pentan-1-ol), poly(5-(2,3-dihydrothieno[3,4-b][1,4]dioxin-2-yl)pentan-2-ol), poly(5-(2,3-dihydrothieno[3,4-b][1,4]dioxin-2-yl)pentane-2,3-diol), poly(1-(2,3-dihydrothieno[3,4-b][1,4]dioxin-2-yl)pentane-2,3,4-triol), poly(1-(2,3-dihydrothieno[3,4-b][1,4]dioxin-2-yl) ethan-1-ol), or poly(5-(2,3-dihydrothieno[3,4-b][1,4]dioxin-2-yl)pentan-1-ol)) having hydroxyl or amine groups available for bonding.

In one or more embodiments, the zwitterionic composition may include any one or more embodiments of the first aspect of the present invention wherein said polymer backbone is selected from the group consisting of dextran, cellulose, starch, glycosaminoglycans, mannan, dextrin, agar, agarose, alginic acid, alguronic acid, amylose, alpha glucan, amylopectin, beta-glucan, callose, carrageenan, cellodextrin, chitin, chitosan, chrysolaminarin, cyclodextrin, DEAE-sepharose, ficoll, fructan, fucoidan, galactoglucomannan, galactomannan, gellan gum, glucan, glucomannan, glucuronoxylan, glycocalyx, glycogen, hemicellulose, homopolysaccharide, hypromellose, inulin, laminarin, lentinan, levan polysaccharide, lichenin, mixed-linkage glucan, paramylon, pectic acid, pectin, pentastarch, phytoglycogen, pleuran, polydextrose, polysaccharide peptide, porphyran, pullulan, sepharose, xylan, xyloglucan, zymosan, hyaluronan, heparin, and combinations thereof.

In one or more embodiments, the zwitterionic composition may include any one or more embodiments of the first aspect of the present invention wherein said one or more zwitterionic side chains have a formula selected from the group consisting of:

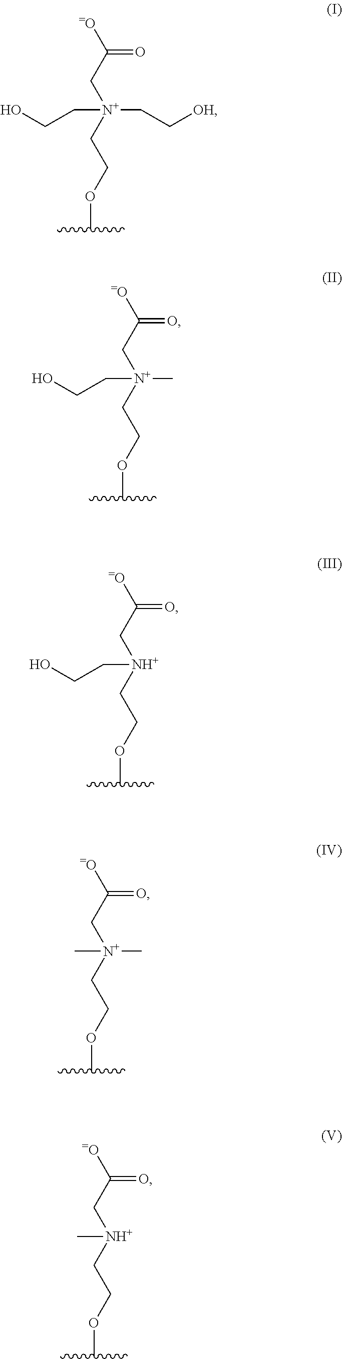

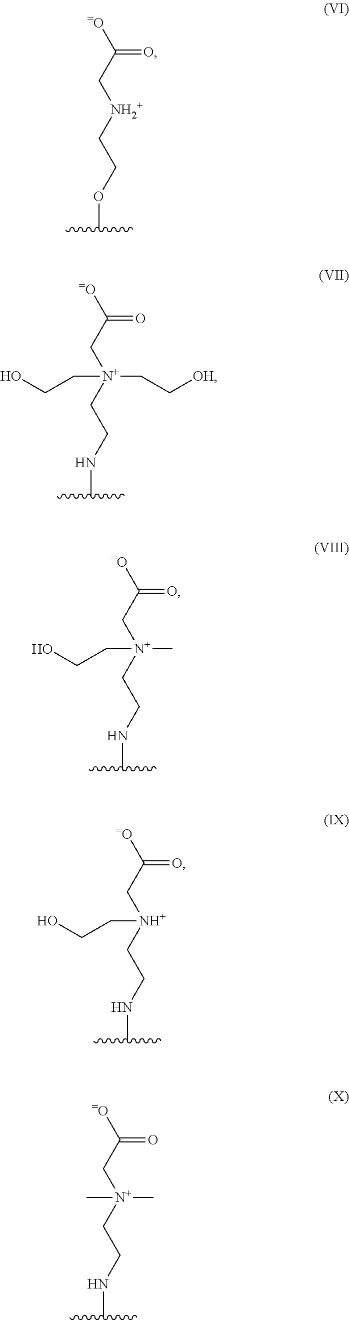

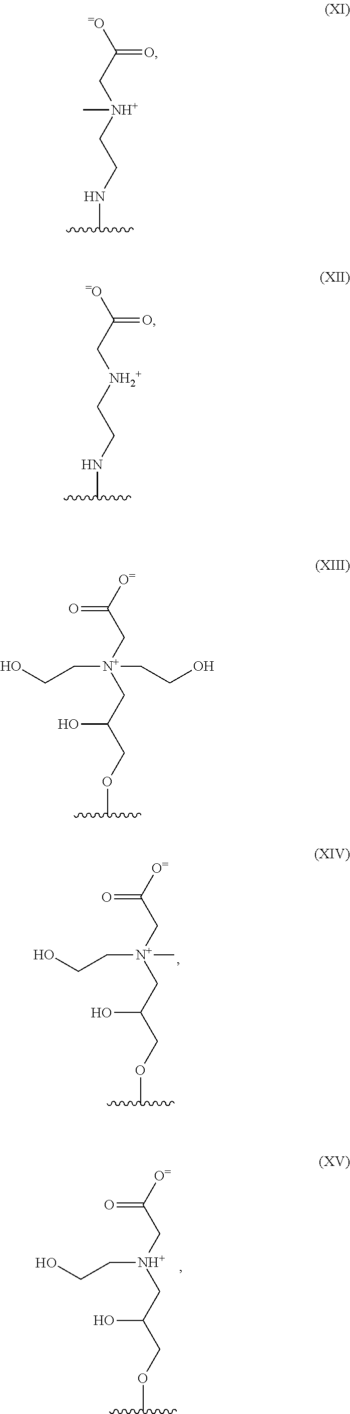

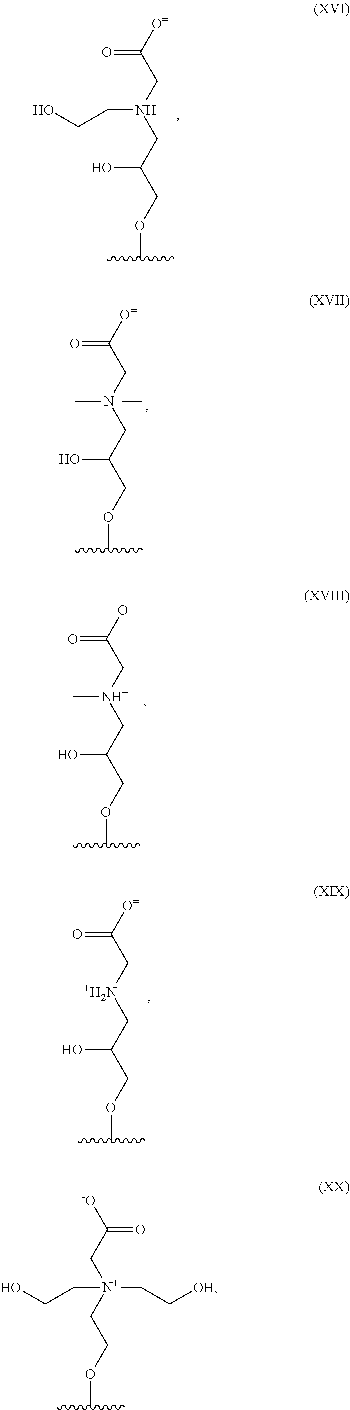

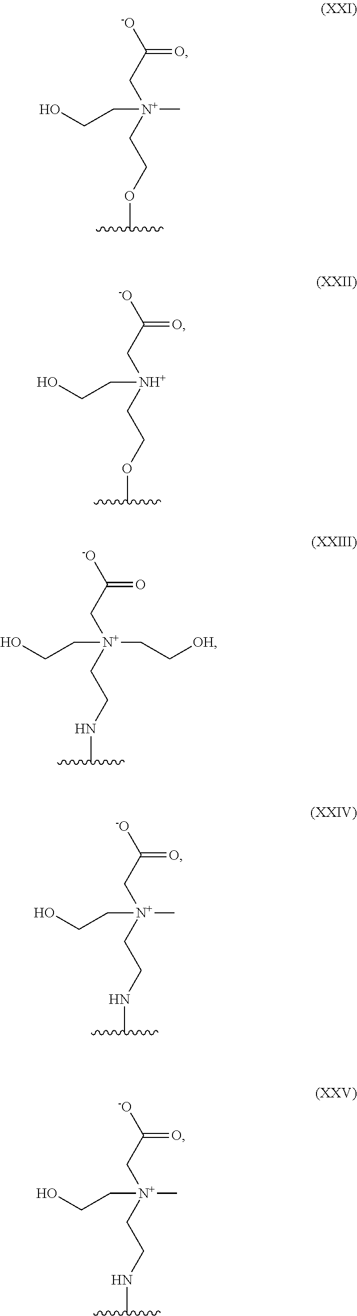

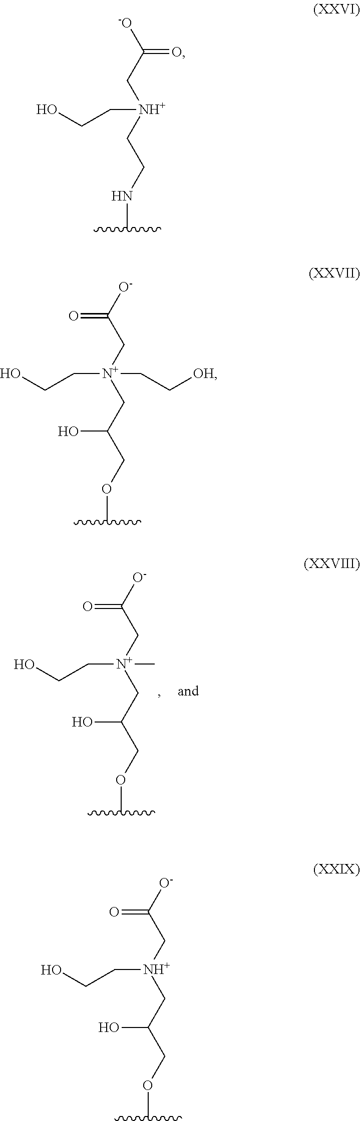

wherein [symbol] is the polymer backbone.

In one or more embodiments, the zwitterionic composition may include any one or more embodiments of the first aspect of the present invention wherein said one or more zwitterionic moieties have a formula selected from:

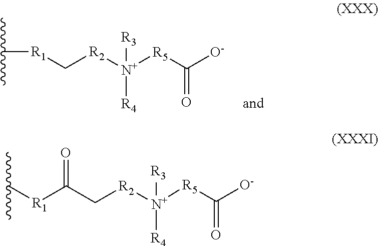

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂CH₂—, or —(CH₂)ₓ—; R₃ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH or —CH₂CH₂CH₂CH₂CH₂OH; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —CH₂—, —CH₂CH₂—, —CH₂CH₂CH₂—, —CH₂CH₂CH₂CH₂—, —CH₂CH₂CH₂CH₂CH₂—, or —(CH₂)_{y}; m, n, x and y are each an integer from 1 to 20; [symbol] the polymer backbone.

In one or more embodiments, the zwitterionic composition may include any one or more embodiments of the first aspect of the present invention wherein said one or more zwitterionic moieties has the formula:

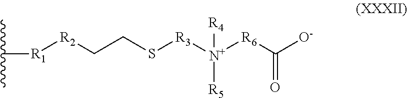

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂CH₂—, —(CH₂)ₓ—, —NHC(O)—, —C(O)NH—, —NHC(O)O—, —NHC(O)CH₂—, —NHC(O)CH₂CH₂—, NHC(O)(CH₂)ₓ—, —NHC(O)O(CH₂)ₓ—, —OC(O)NH(CH₂)ₓ, —OC(O)NH(CH₂)ₓ—, —OC(O)—, —OC(O)CH₂—, —OC(O)CH₂CH₂— or —OC(O)(CH₂)ₓ—; R₃ is —CH₂CH₂—, —CH₂CH₂CH₂—, —CH₂CH₂CH₂CH₂—, —CH₂CH₂CH₂CH₂CH₂—, or —(CH₂)_{y}—; R₄ is —H, —CH₃, —CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or CH₂CH₂CH₂CH₂CH₂OH; R₆ is —CH₂—, —CH₂CH₂—, —CH₂CH₂CH₂—, —CH₂CH₂CH₂CH₂—, —CH₂CH₂CH₂CH₂CH₂— or —(CH₂)_{z}—; m, n, x, y and z are each an integer from 1 to 20; and [symbol] the polymer backbone.

In one or more embodiments, the zwitterionic composition may include any one or more embodiments of the first aspect of the present invention wherein said one or more zwitterionic moieties have the formula:

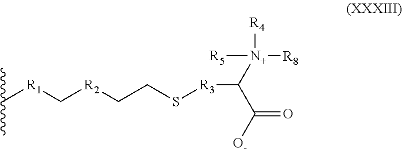

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, —OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂CH₂—, —(CH₂)ₓ—, —NHC(O)—, —NHC(O)CH₂—, —NHC(O)CH₂CH₂—, NHC(O)(CH₂)ₓ—, —OC(O)—, —OC(O)CH₂—, —OC(O)CH₂CH₂— or —OC(O)(CH₂)ₓ—; R₃ is —CH₂CH₂—, —CH₂CH₂CH₂—, —CH₂CH₂CH₂CH₂—, —CH₂CH₂CH₂CH₂CH₂— or —(CH₂)_{y}—; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH or —CH₂CH₂CH₂CH₂CH₂OH; R₆ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; m, n, x and y are each an integer from 1 to 20; and [symbol] is the polymer backbone.

In one or more embodiments, the zwitterionic composition may include any one or more embodiments of the first aspect of the present invention wherein said one or more zwitterionic moieties have the formula:

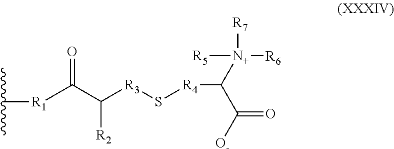

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —C(O)NH(CH₂)ₙ—, —NHC(O)(CH₂)ₙ—, —(CH₂)ₘC(O)NH(CH₂)ₙ—, —NHC(O)(CH₂)ₘC(O)NH—, —OC(O)(CH₂)ₘC(O)NH—, —O(CH₂)ₘC(O)NH—, —NHC(O)(CH₂)ₘO—, —CH₂C(O)O—, —OC(O)CH₂—, —OC(O)CH₂CH₂—, —OC(O)(CH₂)ₘ—, —OC(O)(CH₂)ₘO—, —(CH₂)ₘOC(O)(CH₂)ₙ—, —(CH₂)ₘC(O)O(CH₂)ₙ—, —C(O)O(CH₂)ₙ—, —OC(O)(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂—CH₂CH₃, or —CH₂CH₂CH₃; R₃ is —CH₂—, —CH₂CH₂—, —CH₂CH₂CH₂—, —CH₂CH₂CH₂CH₂—, —CH₂CH₂CH₂CH₂CH₂— or —(CH₂)ₓ—; R₄ is —CH₂CH₂—, —CH₂CH₂CH₂—, —CH₂CH₂CH₂CH₂—, —CH₂CH₂CH₂CH₂CH₂—, or —(CH₂)_{y}—; R₅ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₆ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH or —CH₂CH₂CH₂CH₂CH₂OH; R₇ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH or —CH₂CH₂CH₂CH₂CH₂OH; m, n, x and y are each an integer from 1 to 20; and [symbol] is the—polymer backbone.

In one or more embodiments, the zwitterionic composition may include any one or more embodiments of the first aspect of the present invention wherein said one or more zwitterionic moieties have a formula selected from:

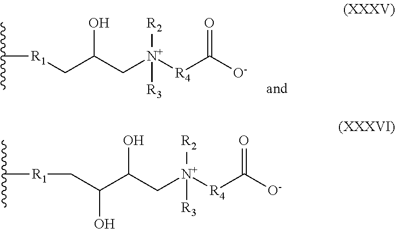

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or CH₂CH₂CH₂CH₂CH₂OH; R₃ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH, R₄ is —CH₂—, —CH₂CH₂—, —CH₂CH₂CH₂—, —CH₂CH₂CH₂CH₂—, —CH₂CH₂CH₂CH₂CH₂— or —(CH₂)ₓ—; m, n and x are each an integer from 1 to 20; and [symbol] is the—polymer backbone.

In one or more embodiments, the zwitterionic composition may include any one or more embodiments of the first aspect of the present invention wherein said one or more zwitterionic moieties have the formula:

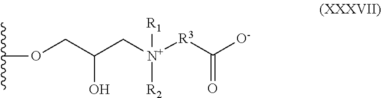

wherein R₁ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₂ are —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₃ is —CH₂—, —CH₂CH₂—, —CH₂CH₂CH₂—, —CH₂CH₂CH₂CH₂—, —CH₂CH₂CH₂CH₂CH₂— or —(CH₂)ₙ—; n is an integer from 1 to 20; and [symbol] is the polymer backbone.

In one or more embodiments, the zwitterionic composition may include any one or more embodiments of the first aspect of the present invention wherein said one or more zwitterionic moieties have the formula:

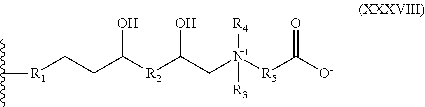

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O) NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂, CH₂CH₂—, —CH₂CH₂CH₂—, —CH₂CH₂CH₂CH₂—, or —(CH₂)ₓ—, R₃ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —CH₂—, —CH₂CH₂—, —CH₂CH₂CH₂—, —CH₂CH₂CH₂CH₂—, —CH₂CH₂CH₂CH₂CH₂— or —(CH₂)_{y}—; m, n, x and y are each an integer from 1 to 20; and [symbol] is the polymer backbone.

In one or more embodiments, the zwitterionic composition may include any one or more embodiments of the first aspect of the present invention wherein the zwitterionic moieties may comprise a carboxybetaine group, a sulfobetaine group, a phosphobetaine group or any combinations thereof. In one or more embodiments, the zwitterionic composition may include any one or more embodiments of the first aspect of the present invention wherein said one or more zwitterionic moieties are selected from the group consisting of 2-(di(methyl)(methylene)ammonio)acetate, 2-((methyl)(methylene)ammonio)acetate, 2-((methylene)ammonio)acetate 2-(bis(2-hydroxyethyl)(methylene)ammonio)acetate, 2-((2-hydroxyethyl)(methylene)(methyl)ammonio)acetate, 2-((2-hydroxyethyl)(methylene)ammonio)acetate, 3-((methyl)(methylene)ammonio) propanoate, 3-(bi(methyl)(methylene)ammonio) propanoate, 3-(bis(2-hydroxyethyl)(methylene)ammonio) propanoate, 3-((2-hydroxyethyl)(methylene)(methyl)ammonio) propanoate, 3-((2-hydroxyethyl)(methylene)ammonio) propanoate, and combinations and analogs/derivatives thereof. In one or more embodiments, the zwitterionic composition may include any one or more embodiments of the first aspect of the present invention wherein said each of said one or more zwitterionic moieties has a corresponding cationic ring form.

In one or more embodiments, the zwitterionic composition may include any one or more embodiments of the first aspect of the present invention wherein the cationic ring form has a formula selected from:

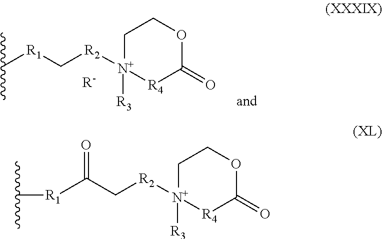

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O) (CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, —OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ—, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂—, or —(CH₂)ₓ₋₁—; R₃ is —H, —CH₃, —CH₂CH₃, —CH₂CH₂CH₃, —CH₂CH₂CH₂CH₃, CH₂CH₂OH, —CH₂CH₂CH₂OH, —CH₂CH₂CH₂CH₂OH, or —CH₂CH₂CH₂CH₂CH₂OH; R₄ is —CH₂—, —CH₂CH₂—, —CH₂CH₂CH₂—, —CH₂CH₂CH₂CH₂—, —CH₂CH₂CH₂CH₂CH₂—, —(CH₂)_{y}— or —(CH₂)_{y}O(CH₂)_{z}—; R⁻ is any organic or inorganic anion; m, n, x, y and z are each an integer from 1 to 20; and [symbol] is the polymer backbone.

In one or more embodiments, the zwitterionic composition may include any one or more embodiments of the first aspect of the present invention wherein the cationic ring form of said one or more zwitterionic moieties has the formula:

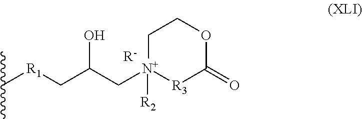

wherein R₁ is —H, —CH₃, —CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₂ is —CH₂—, —CH₂CH₂—, —CH₂CH₂CH₂—, —CH₂CH₂CH₂CH₂—, —CH₂CH₂CH₂CH₂CH₂—, —(CH₂)_{y}— or —(CH₂)_{y}O(CH₂)_{z}—; R⁻ is any organic or inorganic anion; y and z are each an integer from 1 to 20; and [symbol] is the polymer backbone.

In one or more embodiments, the zwitterionic composition may include any one or more embodiments of the first aspect of the present invention wherein the cationic ring form of said one or more zwitterionic moieties has the formula:

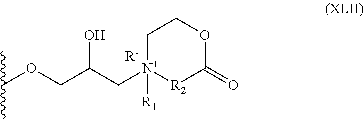

wherein R₁ is —H, —CH₃, —CH₂CH₃, —CH₂CH₂CH₃, —CH₂CH₂CH₂CH₃, —CH₂CH₂OH, —CH₂CH₂CH₂OH, —CH₂CH₂CH₂CH₂OH or —CH₂CH₂CH₂CH₂CH₂OH; R₂ is —CH₂—, —CH₂CH₂—, —CH₂CH₂CH₂—, —CH₂CH₂CH₂CH₂, or —CH₂CH₂CH₂CH₂CH₂—; R⁻ is any organic or inorganic anion; and [symbol] is the polymer backbone. R₁ is —H, —CH₃, —CH₂CH₃, —CH₂CH₂CH₃, —CH₂CH₂CH₂CH₃, —CH₂CH₂OH, —CH₂CH₂CH₂OH, —CH₂CH₂CH₂CH₂OH or —CH₂CH₂CH₂CH₂CH₂OH; R₂ is —CH₂—, —CH₂CH₂—, —CH₂CH₂CH₂—, —CH₂CH₂CH₂CH₂—, —CH₂CH₂CH₂CH₂CH₂—, —(CH₂)_{y}— or —(CH₂)_{y}O(CH₂)_{z}—; R⁻ is any organic or inorganic anion; y and z are each an integer from 1 to 20; and [symbol] is the polymer backbone.

In one or more embodiments, the zwitterionic composition may include any one or more embodiments of the first aspect of the present invention wherein the cationic ring form of said one or more zwitterionic moieties has the formula:

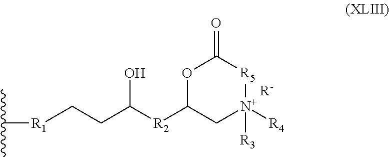

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂, CH₂CH₂—, —CH₂CH₂CH₂— or —CH₂CH₂CH₂CH₂—; R₃ is —H, —CH₃, CH₂CH₃, —CH₂CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —CH₂—, —CH₂CH₂—, —CH₂CH₂CH₂—, —CH₂CH₂CH₂CH₂—, or —CH₂CH₂CH₂CH₂CH₂—, —(CH₂)_{y}— or —(CH₂)_{y}O(CH₂)_{z}—; m, n, y and z are each an integer from 1 to 20; and [symbol] is the polymer backbone.

In one or more embodiments, the zwitterionic composition may include any one or more embodiments of the first aspect of the present invention wherein the cationic ring form of said one or more zwitterionic moieties has a formula selected from the group consisting of:

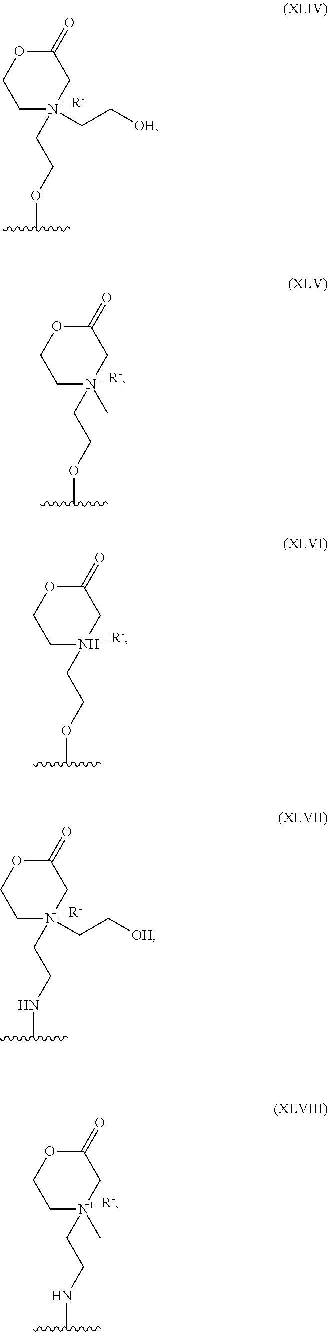

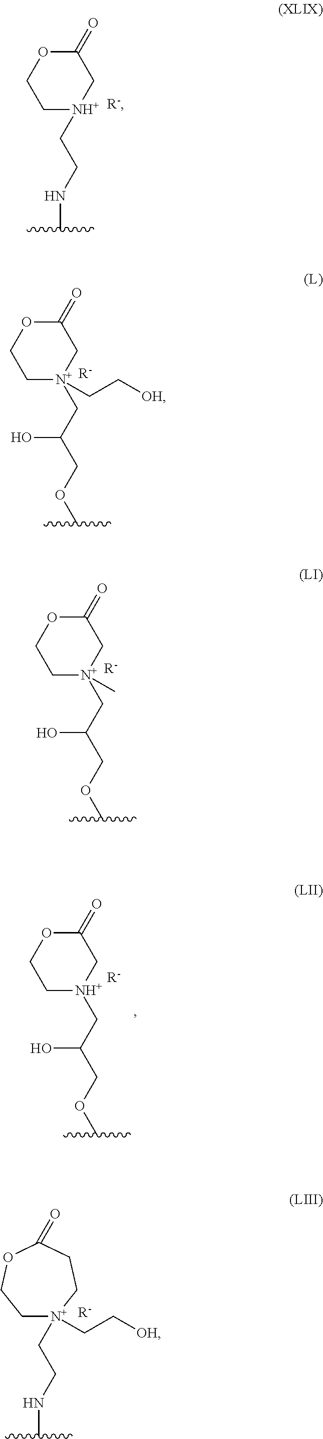

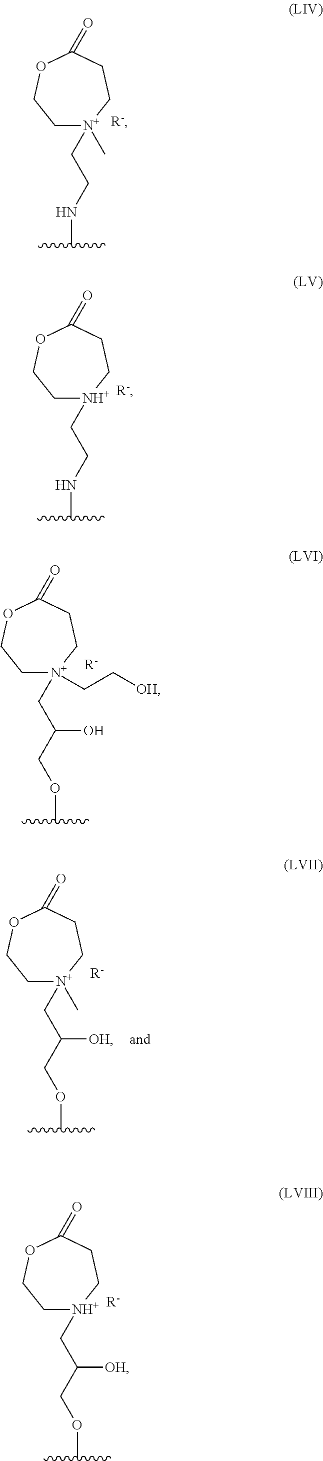

wherein R⁻ is any organic or inorganic anion and [symbol] is the polymer backbone.

In one or more embodiments, the zwitterionic composition may include any one or more embodiments of the first aspect of the present invention further comprising one or more methacrylate, acrylate, acrylamide, methacrylamide side chains or combination thereof. In one or more embodiments, the zwitterionic composition may include any one or more embodiments of the first aspect of the present invention wherein said one or more methacrylate, acrylate, acrylamide, methacrylamide side chains or combination thereof cross link said composition. In one or more embodiments, the zwitterionic composition may include any one or more embodiments of the first aspect of the present invention wherein said composition is a hydrogel. In one or more embodiments, the zwitterionic composition may include any one or more embodiments of the first aspect of the present invention wherein the ratio of said one or more methacrylate, acrylate, acrylamide, methacrylamide side chains or combination thereof to glucose units in said polysaccharide polymer backbone is from 0.1% to 300%.

In one or more embodiments, the zwitterionic composition may include any one or more embodiments of the first aspect of the present invention further comprising a crosslinking compound. In one or more embodiments, the zwitterionic composition may include any one or more embodiments of the first aspect of the present invention wherein said one or more crosslinking compound comprises a compound selected from the group consisting of di(methyl)acrylates, multi-(methyl)acrylates, di(methyl)acrylamides, multi-(methyl)acrylamides, diepoxides, multi-epoxides, dithiols and multi-thiols, or combinations thereof. In one or more embodiments, the zwitterionic composition may include any one or more embodiments of the first aspect of the present invention wherein said one or more crosslinking compound is selected from the group consisting of carboxybetaine di(methyl)acrylate, carboxybetaine di(methyl)acrylamide, poly(ethylene glycol) di(methyl)acrylate, 1,3-propanedithiol, 1,4-butanedithiol, 1,3-butadiene diepoxide, and combinations and/or analogs thereof.

In a second aspect, the present invention provides a method for forming the novel zwitterionic polymer composition described above comprising preparing a polymer chain with hydroxyl and/or amine groups available for bonding and reacting said polymer chain with zwitterionic betaine carrying one primary amine, secondary amine or tertiary amine, and a dibromoalkanes, dichloroalkanes, diepoxide, multi halide substituted alkane, multi epoxide substituted alkane, multi halide and epoxide substituted alkane or combination thereof in the presence of an organic or inorganic base to produce a zwitterionic polymer composition. In one or more embodiments, the second step may comprise reacting said polymer chain with an ester derivative of zwitterionic betaine that contains one primary amine, secondary amine or tertiary amine, and dibromoalkane, dichloroalkane, diepoxide, multi halide substituted alkane, or multi halide epoxide substituted alkane to produce a cationic polymer composition; and further comprising hydrolyzing said cationic polymer in acidic or basic conditions to produce a zwitterionic polymer composition In one or more embodiments, the method of forming a zwitterionic polymer composition may include any one or embodiments of the second aspect of the present invention wherein said polymer chain comprises a polysaccharide polymer chain. In one or more embodiments, the method of forming a zwitterionic polymer composition may include any one or more embodiments of the second aspect of the present invention wherein the second step comprises reacting said polymer chain with dimethylglycine and epichlorohydrin in the presence of an organic and inorganic base to produce a zwitterionic polysaccharide composition. In one or more embodiments, the method of forming a zwitterionic polymer composition may include any one or more embodiments of the second aspect of the present invention wherein the second step comprises reacting said polymer chain with 3-bromopropanoyl bromide or 2-bromoacetyl bromide, and zwitterionic betaine carrying a tertiary amine in the presence of an organic and inorganic base to produce a zwitterionic polysaccharide composition. In one or more embodiments, the method of forming a zwitterionic polymer composition may include any one or more embodiments of the second aspect of the present invention wherein the second step comprises reacting said polymer chain with 3-bromopropanoyl bromide or 2-bromoacetyl bromide, and ester derivative of zwitterionic betaine carrying a tertiary amine in the presence of an organic and inorganic base to produce a cationic polymer composition; and further comprising hydrolyzing said cationic polymer composition in acidic or basic conditions to produce a zwitterionic polymer composition.

In one or more embodiments, the method of forming a zwitterionic polymer composition may include any one or more embodiments of the second aspect of the present invention wherein said polymer chain comprises a (poly(vinyl alcohol), poly(2-hydroxyethyl methacrylate), poly(2-hydroxyethyl acrylate), poly(3-hydroxypropyl methacrylate), poly(3-hydroxypropyl acrylate), poly(4-hydroxybutyl methacrylate), poly(5-hydroxypentyl acrylate), poly(5-hydroxypentyl methacrylate), poly(4-hydroxybutyl acrylate), poly(n-(2-hydroxyethyl) methacrylamide), poly(N-(3-hydroxypropyl) methacrylamide), poly(N-(4-hydroxybutyl) methacrylamide), poly(N-(5-hydroxypentyl) methacrylamide), poly(N-(2-hydroxyethyl)acrylamide), poly(N-(3-hydroxypropyl) acrylamide), poly(N-(4-hydroxybutyl) acrylamide), poly(N-(5-hydroxypentyl)acrylamide), poly(serine), poly(lysine), poly(amine), poly(phenol), poly(1-glycerol methacrylate), poly(2,3-dihydrothieno[3,4-b][1,4]dioxin-2-yl)methanol), poly(2-(2,3-dihydrothieno[3,4-b][1,4]dioxin-2-yl)ethan-1-ol), poly(3-(2,3-dihydrothieno[3,4-b][1,4]dioxin-2-yl)propan-1-ol), poly(1-(2,3-dihydrothieno[3,4-b][1,4]dioxin-2-yl)propan-2-ol), poly(3-(2,3-dihydrothieno[3,4-b][1,4]dioxin-2-yl) propane-1,2-diol), poly(4-(2,3-dihydrothieno[3,4-b][1,4]dioxin-2-yl) butan-1-ol), poly(5-(2,3-dihydrothieno[3,4-b][1,4]dioxin-2-yl)pentan-1-ol), poly(5-(2,3-dihydrothieno[3,4-b][1,4]dioxin-2-yl)pentan-2-ol), poly(5-(2,3-dihydrothieno[3,4-b][1,4]dioxin-2-yl)pentane-2,3-diol), poly(1-(2,3-dihydrothieno[3,4-b][1,4]dioxin-2-yl)pentane-2,3,4-triol), poly(1-(2,3-dihydrothieno[3,4-b][1,4]dioxin-2-yl) ethan-1-ol), or poly(5-(2,3-dihydrothieno[3,4-b][1,4]dioxin-2-yl)pentan-1-ol)) having hydroxyl or amine groups available for bonding.

In one or more embodiments, the method of forming a zwitterionic polymer composition may include any one or more embodiments of the second aspect of the present invention wherein said polysaccharide polymer chain further comprises a saccharide selected from the group consisting of dextran, cellulose, starch, glycosaminoglycans, mannan, dextrin, agar, agarose, alginic acid, alguronic acid, amylose, alpha glucan, amylopectin, beta-glucan, callose, carrageenan, cellodextrin, chitin, chitosan, chrysolaminarin, cyclodextrin, DEAE-sepharose, ficoll, fructan, fucoidan, galactoglucomannan, galactomannan, gellan gum, glucan, glucomannan, glucuronoxylan, glycocalyx, glycogen, hemicellulose, homopolysaccharide, hypromellose, inulin, laminarin, lentinan, levan polysaccharide, lichenin, mixed-linkage glucan, paramylon, pectic acid, pectin, pentastarch, phytoglycogen, pleuran, polydextrose, polysaccharide peptide, porphyran, pullulan, sepharose, xylan, xyloglucan, zymosan, hyaluronan, heparin, and combinations thereof. In one or more embodiments, the method of forming a zwitterionic polymer composition may include any one or more embodiments of the second aspect of the present invention further comprising purifying the product of the second step by using a dialysis membrane or by precipitation in a suitable solvent and lyophilizing or drying the recovered product.

In one or more embodiments, the method of forming a zwitterionic polymer composition may include any one or more embodiments of the second aspect of the present invention further comprising adding methacrylate crosslinking groups to the product of the second step by treatment with glycidyl methacrylate. In one or more embodiments, the method of forming a zwitterionic polymer composition may include any one or more embodiments of the second aspect of the present invention further comprising adding acrylate, acrylamide, methacrylamide or combination thereof crosslinking groups to the product of the second step. In one or more embodiments, the method of forming a zwitterionic polymer composition may include any one or more embodiments of the second aspect of the present invention further comprising purifying the glycidyl methacrylate treated product using a dialysis membrane or precipitation in a suitable solvent and lyophilizing or drying the recovered product.

In one or more embodiments, the method of forming a zwitterionic polymer composition may include any one or more embodiments of the second aspect of the present invention further comprising: dissolving the recovered product of in water; adding a free radical initiator; and activating said free radical initiator and to initiate crosslinking of the methacrylate, acrylate, acrylamide or methacrylamide groups and form a hydrogel. In one or more embodiments, the method of forming a zwitterionic polymer composition may include any one or more embodiments of the second aspect of the present invention wherein said free radical initiator is selected from the group consisting of an azo compound, an inorganic peroxide, an organic peroxide, 2-hydroxy-4′-(2-hydroxyethoxy)-2-methylpropiophenone, 4,4′-azobis(4-cyanovaleric acid), 1,1′-azobis(cyclohexanecarbonitrile), 2,2′-azobis(2-methylpropionitrile), 2,2′-azobis[2-(2-imidazolin-2-yl)propane]dihydrochloride, 2,2′-azobis[2-(2-imidazolin-2-yl) propane]disulfate dehydrate, 2,2′-azobis(2-methylpropionamidine)dihydrochloride and combinations thereof. In one or more embodiments, the method of forming a zwitterionic polymer composition may include any one or more embodiments of the second aspect of the present invention wherein said zwitterionic betaine is selected from the group consisting or 2-(di(methyl)(methylene)ammonio)acetate, 2-((methyl)(methylene)ammonio)acetate, 2-((methylene)ammonio)acetate 2-(bis(2-hydroxyethyl)(methylene)ammonio)acetate, 2-((2-hydroxyethyl)(methylene)(methyl)ammonio)acetate, 2-((2-hydroxyethyl)(methylene)ammonio)acetate, 3-((methyl)(methylene)ammonio) propanoate, 3-(bi(methyl)(methylene)ammonio) propanoate, 3-(bis(2-hydroxyethyl)(methylene)ammonio) propanoate, 3-((2-hydroxyethyl)(methylene)(methyl)ammonio) propanoate, 3-((2-hydroxyethyl)(methylene)ammonio) propanoate, and combinations and analogs/derivatives thereof.

In one or more embodiments, the method of forming a zwitterionic polymer composition may include any one or more embodiments of the second aspect of the present invention wherein said zwitterionic betaine is selected from the group consisting or 2-(di(methyl)(methylene)ammonio)acetate, 2-((methyl)(methylene)ammonio)acetate, 2-((methylene)ammonio)acetate 2-(bis(2-hydroxyethyl)(methylene)ammonio)acetate, 2-((2-hydroxyethyl)(methylene)(methyl)ammonio)acetate, 2-((2-hydroxyethyl)(methylene)ammonio)acetate, 3-((methyl)(methylene)ammonio) propanoate, 3-(bi(methyl)(methylene)ammonio) propanoate, 3-(bis(2-hydroxyethyl)(methylene)ammonio) propanoate, 3-((2-hydroxyethyl)(methylene)(methyl)ammonio) propanoate, 3-((2-hydroxyethyl)(methylene)ammonio) propanoate, and combinations and analogs/derivatives thereof. In one or more embodiments, the method of forming a zwitterionic polymer composition may include any one or more embodiments of the second aspect of the present invention wherein said zwitterionic compound further comprises a carboxybetaine group.

In a third aspect, the present invention provides a method for forming the novel zwitterionic polymer composition described above comprising preparing a polymer chain with carboxylate available for bonding and reacting said polymer chain with a molecule with one hydroxyl group or primary amine group at one end and tertiary amine on the other end. The second step may comprise reacting said polymer chain with a molecule with one halide at one end and carboxylate ester on the other end to produce a cationic polymer composition; and further comprising hydrolyzing said cationic polymer in acidic or basic conditions to produce a zwitterionic polymer composition. In one or more embodiments, the second step may comprise reacting said polymer chain with a molecule with one halide at one end and carboxylate on the other end to produce a zwitterionic polymer composition in basic conditions. In one or more embodiments, the polymer in the second step may then be reacted with an ethyl bromoacetate to produce a cationic polymer composition; and further comprising hydrolyzing said cationic polymer in acidic or basic conditions to produce a zwitterionic polymer composition. In one or more embodiments, the first step may comprise reacting said polymer chain with carboxylate available with the molecule with primary amine at one end and carboxybetaine ester on the other end to produce a cationic polymer composition; and further comprising hydrolyzing said cationic polymer in acidic or basic conditions to produce a zwitterionic polymer composition. In one or more embodiments, the method of forming a zwitterionic polymer composition may include any one or embodiments of the third aspect of the present invention wherein said polymer chain comprises a polysaccharide polymer chain.

In a forth aspect, the present invention provides a method for forming the zwitterionic polymer composition described above comprising preparing a polymer chain with hydroxyl or amine available for bonding. The second step may comprise reacting said polymer chain with a molecule with zwitterionic betaine carrying one tertiary amine, and a molecule with one acyl halide at one end and halide on the other end in the presence of an organic or inorganic base to produce a zwitterionic polymer composition. In one or more embodiments, the second step may comprise reacting said polymer chain with an ester derivative of zwitterionic betaine that contains one tertiary amine, and a molecule with one acyl halide at one end and halide on the other end to produce a cationic polymer composition; and further comprising hydrolyzing said cationic polymer in acidic or basic conditions to produce a zwitterionic polymer composition. In one or more embodiments, the method of forming a zwitterionic polymer composition may include any one or embodiments of the fourth aspect of the present invention wherein said polymer chain comprises a polysaccharide polymer chain.

### BRIEF DESCRIPTION OF THE DRAWINGS

For a more complete understanding of the features and advantages of the present invention, reference is now made to the detailed description of the invention along with the accompanying figures in which:

FIG. 1 is a chart showing the GPC profiles of unmodified dextran as well as CB-L-Dex and CB-H-Dex polymers according to one or more embodiments of the present invention. The inset table summarizes the M_{w} and polydispersity index (PDI) of each polymer.

FIG. 2A is a 300 MHz ¹H NMR spectra of Dextran.

FIG. 2B is a 300 MHz ¹H NMR spectra of a Dex-MA polymer according to one or more embodiments of the present invention.

FIG. 2C is a 300 MHz 1H NMR spectra of a CB-L-Dex polymer according to one or more embodiments of the present invention.

FIG. 2D is a 300 MHz 1H NMR spectra of a CB-H-Dex polymer according to one or more embodiments of the present invention.

FIG. 3 is a diagram showing the structural switch between zwitterionic form and cationic form for a CB-L-Dex polymer according to one or more embodiments of the present invention.

FIG. 4 is a 750 MHz 1H-13C gHMBC NMR spectrum of a CB-H-Dex polymer according to one or more embodiments of the present invention in its cationic ring form. The cross-peak in dotted circle indicated the ring structure formation of the CB side chain.

FIG. 5 is a graph showing the change of NMR spectra from zwitterionic form to its cationic ring form in TFA-d of a CB-L-Dex polymer according to one or more embodiments of the present invention.

FIG. 6 is a graph showing the conversion kinetics from zwitterionic form to its cationic ring form in TFA-d for a CB-L-Dex polymer according to one or more embodiments of the present invention.

FIG. 7 is a graph showing the conversion kinetics from ring form to zwitterionic form in D2O for a CB-L-Dex polymer according to one or more embodiments of the present invention.

FIGS. 8A-D are images showing the results of protein (FITC-Fg) fouling tests on hydrogels according to one or more embodiments of the present invention visualized under fluorescence microscope at the same excitation light intensity and exposure time. These images were focused on the edge of the upper surface of each hydrogel sample. FIG. 8A is a Dex-MA polymer according to one or more embodiments of the present invention; FIG. 8B is a CB-L-Dex polymer according to one or more embodiments of the present invention; FIG. 8C is a CB-H-Dex polymer according to one or more embodiments of the present invention; and FIG. 8D) is a control hydrogel surface with no protein contact.

FIGS. 9A-D are images showing the results of bovine aortic endothelium cells' (BAECs) attachment test on hydrogel surfaces comprising tissue culture polystyrene (TCPS) (FIG. 9A); Dex-MA (FIG. 9B); a CB-L-Dex polymer according to one or more embodiments of the present invention (FIG. 9C); and a CB-H-Dex polymer according to one or more embodiments of the present invention (FIG. 9D).

FIG. 10A-B are digital images showing a top view (FIG. 10A) and a side view (FIG. 10B) of dextran hydrogels according to one or more embodiments of the present invention showing (from left to right): Dex-MA; CB-L-Dex; and CB-H-Dex. A).

FIG. 11 is a chart showing the GPC traces of the enzyme degradation products of dextran after 0 minute, 5 minutes, 60 minutes

FIG. 12 is a chart showing the GPC traces of the enzyme degradation products of a CB-L-Dex polymer according to one or more embodiments of the present invention after 0 minute, 5 minutes, and 60 minutes in 0.2 U/mL of dextranase.

### DETAILED DESCRIPTION OF THE ILLUSTRATIVE EMBODIMENTS

In general outline, the present invention is directed to a versatile and high performance zwitterionic polysaccharide platform for various biotech and biomedical applications that addresses the deficiencies found in existing polysaccharide materials. Embodiments of the present invention depart from the conventional approach of blending of polysaccharide with other functional materials by integrating all required functions (e.g. enhanced antifouling, biocompatibility, functionality for further modification, sensitivity to environmental stimuli and antimicrobial properties) into one polymer chain. The integrated zwitterionic polysaccharides of various embodiments of the present invention consist of a degradable polysaccharide backbone and multifunctional zwitterionic side chains. These polysaccharides can obtain excellent biocompatibility, sensitivity to environmental stimuli, functional groups for bioconjugation and antimicrobial property via multifunctional zwitterionic side chains, while zwitterionic materials can obtain biodegradability from the polysaccharide backbone.

As used herein, the terms “polymer backbone” and “polymer chain” are used interchangeably to refers to the polymer chain that forms the backbone of the zwitterionic compositions described and claimed herein

As used herein, the term “carboxybetaine” refers to any neutral chemical compound with a positively charged cationic functional group and with a negatively charged carboxylate group. The term “carboxybetaine-based” therefore refers to the compound containing one or more carboxybetaine moieties.

As used herein, the term “zwitterionic” refers to neutral in electrical charge, which is balanced by a positive and a negative electrical charge.

As used herein, the term “lactone ring form” “cationic ring form” are used interchangeably to refer to a cyclic structure that has an ester bond and one group is positively charged.

As used herein, the term “hydrogel” refers to a material is a network of polymer chains that are hydrophilic and contain water as the dispersion medium. As used herein, the term “elastomer” refers to is a material with viscoelasticity and very weak inter-molecular forces, generally having low Young's modulus and high failure strain compared with other materials.

As used herein, the term “degree of substitution” used in connection with the zwitterionic composition of the present invention refers to the number of side chains per 100 glucose (or other monosaccharide) units of the polysaccharide polymer backbone.

In a first aspect, embodiments of the present invention are directed to a novel zwitterionic polymer composition having excellent anti-fouling, switchability, antimicrobial and optical properties. In these embodiments, the zwitterionic polymer composition comprises a polymer backbone having one or more zwitterionic side chains chemically bonded thereto.

The polymer selected for use as the polymer backbone of embodiments of the present invention is not particularly limited, but must be able to add one or more zwitterionic side chains. These polymers may include, without limitation polysaccharides, poly(serine), poly(vinyl alcohol), poly((2,3-Dihydrothieno[3,4-b][1,4]dioxin-2-yl)methanol), poly(2-hydroxyethyl methacrylate), or a polyol. Suitable polymers may include without limitation, comprises a poly(vinyl alcohol), poly(2-hydroxyethyl methacrylate), poly(2-hydroxyethyl acrylate), poly(3-hydroxypropyl methacrylate), poly(3-hydroxypropyl acrylate), poly(4-hydroxybutyl methacrylate), poly(5-hydroxypentyl acrylate), poly(5-hydroxypentyl methacrylate), poly(4-hydroxybutyl acrylate), poly(N-(2-hydroxyethyl) methacrylamide), poly(N-(3-hydroxypropyl) methacrylamide), poly(N-(4-hydroxybutyl) methacrylamide), poly(N-(5-hydroxypentyl) methacrylamide), poly(N-(2-hydroxyethyl)acrylamide), poly(N-(3-hydroxypropyl) acrylamide), poly(N-(4-hydroxybutyl) acrylamide), poly(N-(5-hydroxypentyl)acrylamide), poly(serine), poly(lysine), poly(amine), poly(phenol), poly(1-glycerol methacrylate), poly(2,3-dihydrothieno[3,4-b][1,4]dioxin-2-yl)methanol), poly(2-(2,3-dihydrothieno[3,4-b][1,4]dioxin-2-yl)ethan-1-ol), poly(3-(2,3-dihydrothieno[3,4-b][1,4]dioxin-2-yl)propan-1-ol), poly(1-(2,3-dihydrothieno[3,4-b][1,4]dioxin-2-yl)propan-2-ol), poly(3-(2,3-dihydrothieno[3,4-b][1,4]dioxin-2-yl) propane-1,2-diol), poly(4-(2,3-dihydrothieno[3,4-b][1,4]dioxin-2-yl) butan-1-ol), poly(5-(2,3-dihydrothieno[3,4-b][1,4]dioxin-2-yl)pentan-1-ol), poly(5-(2,3-dihydrothieno[3,4-b][1,4]dioxin-2-yl)pentan-2-ol), poly(5-(2,3-dihydrothieno[3,4-b][1,4]dioxin-2-yl)pentane-2,3-diol), poly(1-(2,3-dihydrothieno[3,4-b][1,4]dioxin-2-yl)pentane-2,3,4-triol), poly(1-(2,3-dihydrothieno[3,4-b][1,4]dioxin-2-yl) ethan-1-ol), or poly(5-(2,3-dihydrothieno[3,4-b][1,4]dioxin-2-yl)pentan-1-ol)) having hydroxyl or amine groups available for bonding.

In one or more embodiment, the polymer backbone may be comprised of a polysaccharide polymer. In some embodiments, these polysaccharide polymers have one or more hydroxyl or amine groups available for bonding. Suitable polysaccharide polymers include, without limitation dextran, cellulose, starch, glycosaminoglycans, mannan, dextrin, agar, agarose, alginic acid, alguronic acid, amylose, alpha glucan, amylopectin, beta-glucan, callose, carrageenan, cellodextrin, chitin, chitosan, chrysolaminarin, cyclodextrin, DEAE-sepharose, ficoll, fructan, fucoidan, galactoglucomannan, galactomannan, gellan gum, glucan, glucomannan, glucuronoxylan, glycocalyx, glycogen, hemicellulose, homopolysaccharide, hypromellose, inulin, laminarin, lentinan, levan polysaccharide, lichenin, mixed-linkage glucan, paramylon, pectic acid, pectin, pentastarch, phytoglycogen, pleuran, polydextrose, polysaccharide peptide, porphyran, pullulan, sepharose, xylan, xyloglucan, zymosan, hyaluronan, heparin, or combination thereof.

Chemically bonded to the polysaccharide polymer backbone are one or more zwitterionic side chains. The zwitterionic side chains of embodiments of the present invention are bonded at one end to the polymer backbone and contain a zwitterionic functional group. In some embodiments, the zwitterionic side chains are bonded to a glucose or other saccharide group in the polymer backbone. (See Scheme 1, below) In some embodiments, the zwitterionic side chains may be bonded to the polymer backbone at an available hydroxyl, amide or carboxylate group.

In some embodiments, zwitterionic functional group may be a zwitterionic betaine group. In some embodiments, the zwitterionic functional group may be a carboxybetaine group. In some embodiments, the zwitterionic betaine may include, without limitation, 2-(di(methyl)(methylene)ammonio)acetate, 2-((methyl)(methylene)ammonio)acetate, 2-((methylene)ammonio)acetate 2-(bis(2-hydroxyethyl)(methylene)ammonio)acetate, 2-((2-hydroxyethyl)(methylene)(methyl)ammonio)acetate, 2-((2-hydroxyethyl)(methylene)ammonio)acetate, 3-((methyl)(methylene)ammonio) propanoate, 3-(bi(methyl)(methylene)ammonio) propanoate, 3-(bis(2-hydroxyethyl)(methylene)ammonio) propanoate, 3-((2-hydroxyethyl)(methylene)(methyl)ammonio) propanoate, 3-((2-hydroxyethyl)(methylene)ammonio) propanoate, or combinations and/or analogs and derivatives thereof.

In some embodiments, the zwitterionic betaine group may be separated from the polysaccharide polymer backbone by from 1 to 100 carbon, oxygen, nitrogen, or sulfur atoms. In some embodiments, the zwitterionic betaine group may be separated from the polysaccharide polymer backbone by from 1 to 10 carbon, oxygen, nitrogen, or sulfur atoms. In some embodiments, the zwitterionic betaine group may be separated from the polysaccharide polymer backbone by from 11 to 50 carbon, oxygen, nitrogen, or sulfur atoms. In some embodiments, the zwitterionic betaine group may be separated from the polysaccharide polymer backbone by from 51 to 100 carbon, oxygen, nitrogen, or sulfur atoms. In some embodiments, the zwitterionic side chains may comprise a carboxybetaine group having at least one ethanol, propanol, butanol or pentanol group bonded to the nitrogen atom of the carboxybetaine group.

In some embodiments, the zwitterionic side chains may have the formula:

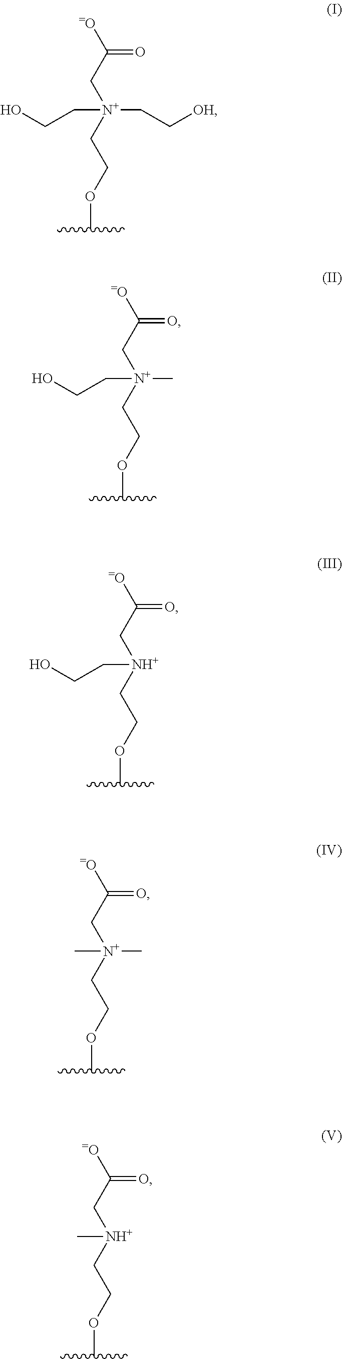

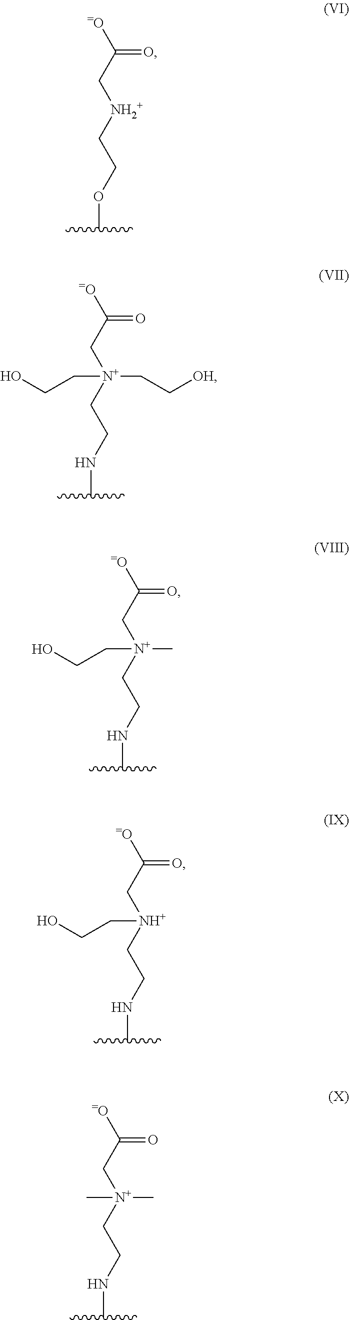

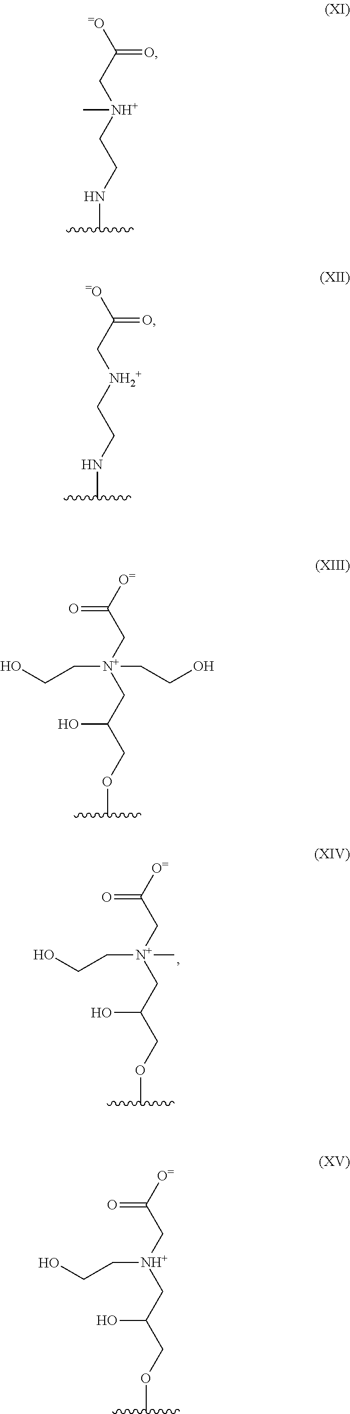

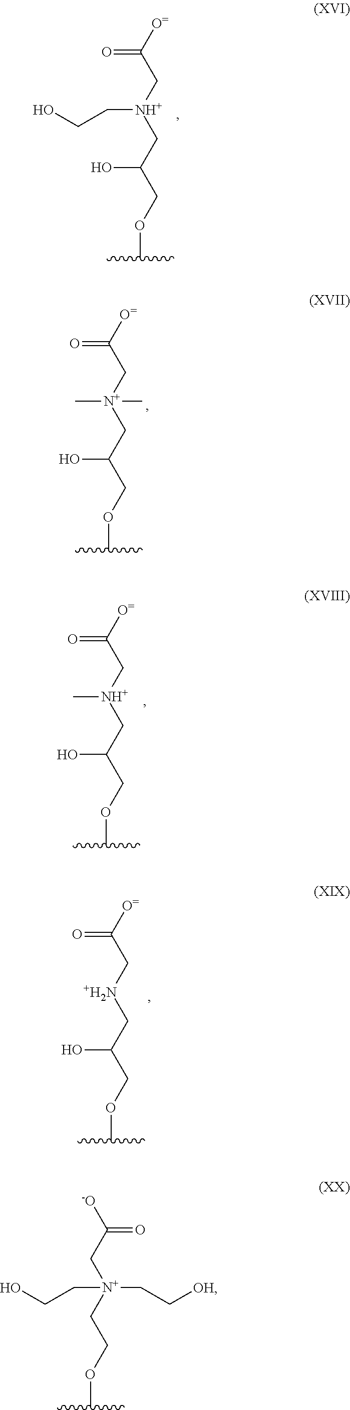

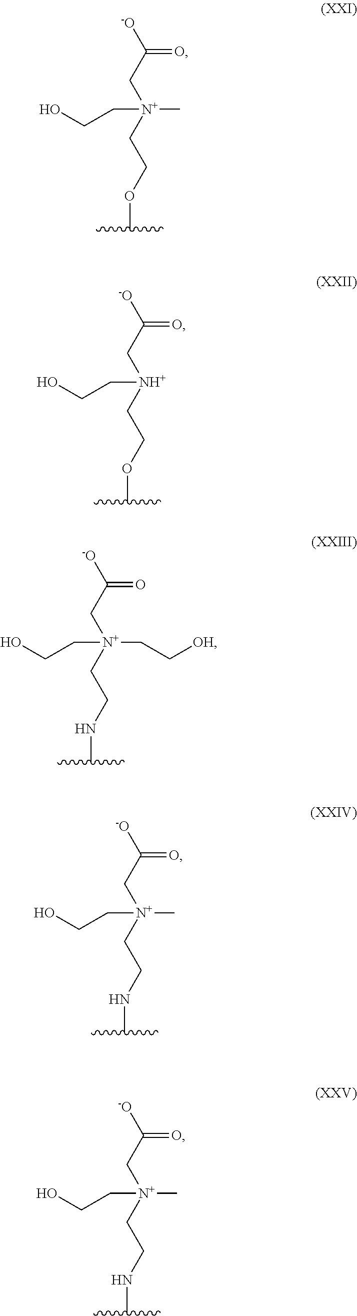

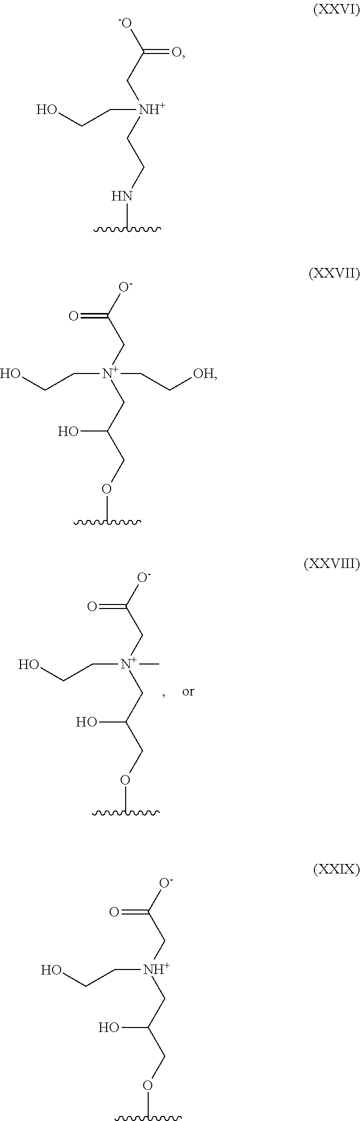

wherein [symbol] is the polymer backbone.

In some embodiments, the zwitterionic side chains may have the formula:

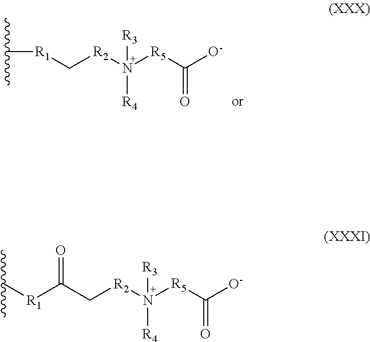

wherein R is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂CH₂—, or —(CH₂)ₓ—; R₃ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or CH₂CH₂CH₂CH₂CH₂OH; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —CH₂—, —CH₂CH₂—, —CH₂CH₂CH₂—, —CH₂CH₂CH₂CH₂—, —CH₂CH₂CH₂CH₂CH₂—, or —(CH₂)_{y}; m, n, x and y are each an integer from 1 to 20; and [symbol] is the polymer backbone. In some embodiments, [symbol] may be a polysaccharide polymer backbone.

In some embodiments, the zwitterionic side chains may have the formula:

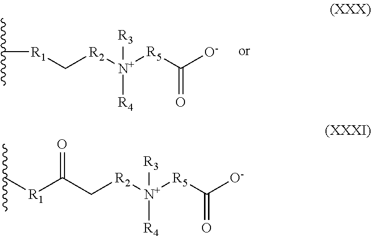

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O) (CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, —OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂CH₂—, —(CH₂)ₓ—, —NHC(O)—, —C(O)NH—, —NHC(O)O—, —NHC(O)CH₂—, —NHC(O)CH₂CH₂—, NHC(O)(CH₂)ₓ—, NHC(O)O(CH₂)ₓ—, OC(O)NH(CH₂), —OC(O)NH(CH₂)ₓ—, —OC(O)—, —OC(O)CH₂—, —OC(O)CH₂CH₂— or —OC(O)(CH₂)ₓ—; R₃ is —CH₂CH₂—, —CH₂CH₂CH₂—, —CH₂CH₂CH₂CH₂—, —CH₂CH₂CH₂CH₂CH₂— or —(CH₂)_{y}—; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₆ is —CH₂—, —CH₂CH₂—, —CH₂CH₂CH₂—, —CH₂CH₂CH₂CH₂—, CH₂CH₂CH₂CH₂CH₂— or —(CH₂)_{z}; m, n, x, y and z are each an integer from 1 to 20; and [symbol] is the polymer backbone. In some embodiments, [symbol] may be a polysaccharide polymer backbone.

In some embodiments, the zwitterionic side chains may have the formula:

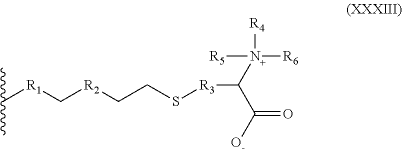

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂CH₂—, —(CH₂)ₓ—, —NHC(O)—, —NHC(O)CH₂—, —NHC(O)CH₂CH₂—, NHC(O)(CH₂)ₓ—, —OC(O)—, —OC(O)CH₂—, —OC(O)CH₂CH₂— or —OC(O)(CH₂)ₓ—; R₃ is —CH₂CH₂—, —CH₂CH₂CH₂—, —CH₂CH₂CH₂CH₂—, —CH₂CH₂CH₂CH₂CH₂— or —(CH₂)_{y}—; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, —CH₂CH₂CH₂CH₂CH₂OH; R₆ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; m, n, x and y are each an integer from 1 to 20; and [symbol] is the polymer backbone. In some embodiments, [symbol] may be a polysaccharide polymer backbone.

In some embodiments, the zwitterionic side chains may have the formula:

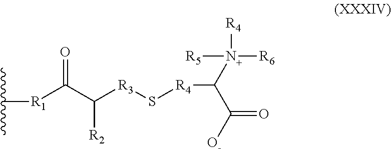

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —C(O)NH(CH₂)ₙ—, —NHC(O)(CH₂)ₙ—, —(CH₂)ₘC(O)NH(CH₂)ₙ—, —NHC(O)(CH₂)ₘC(O)NH—, —OC(O)(CH₂)ₘC(O)NH—, —O(CH₂)ₘC(O)NH—, —NHC(O)(CH₂)ₘO—, —CH₂C(O)O—, —OC(O)CH₂—, —OC(O)CH₂CH₂—, —OC(O)(CH₂)ₘ—, —OC(O)(CH₂)ₘO—, —(CH₂)ₘOC(O)(CH₂)ₙ—, —(CH₂)ₘC(O)O(CH₂)ₙ—, —C(O)O(CH₂)ₙ—, —OC(O)(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂—CH₂CH₃, or —CH₂CH₂CH₃; R₃ is —CH₂—, —CH₂CH₂—, —CH₂CH₂CH₂—, —CH₂CH₂CH₂CH₂—, —CH₂CH₂CH₂CH₂CH₂— or —(CH₂)ₓ—; R₄ is —CH₂CH₂—, —CH₂CH₂CH₂—, —CH₂CH₂CH₂CH₂—, —CH₂CH₂CH₂CH₂CH₂— or —(CH₂)_{y}—; R₅ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₆ is H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₇ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; m, n, x and y are each an integer from 1 to 20; and [symbol] is the polysaccharide polymer backbone.

In some embodiments, the zwitterionic side chains may have the formula:

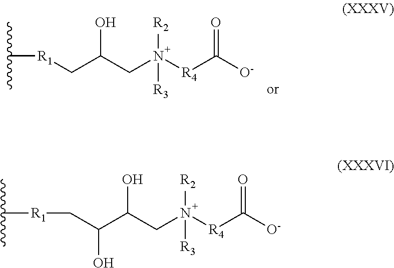

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, —OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₃ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH, R₄ is —CH₂—, —CH₂CH₂—, —CH₂CH₂CH₂—, —CH₂CH₂CH₂CH₂—, —CH₂CH₂CH₂CH₂CH₂— or —(CH₂)ₓ—; m, n and x are each an integer from 1 to 20; and [symbol] is the polymer backbone. In some embodiments, [symbol] may be a polysaccharide polymer backbone.

In some embodiments, the zwitterionic side chains may have the formula:

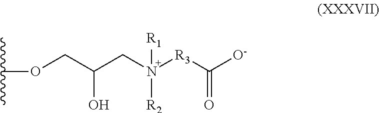

wherein R₁ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₂ are —H, —CH₃, —CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₃ is —CH₂—, —CH₂CH₂—, —CH₂CH₂CH₂—, —CH₂CH₂CH₂CH₂—, —CH₂CH₂CH₂CH₂CH₂— or —(CH₂)ₙ—; n is an integer from 1 to 20; and [symbol] is the polymer backbone. In some embodiments, [symbol] may be a polysaccharide polymer backbone.

In some embodiments, the zwitterionic side chains may have the formula:

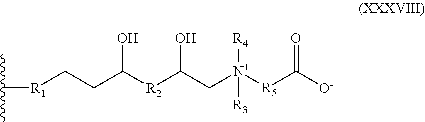

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O) (CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂, CH₂CH₂—, —CH₂CH₂CH₂—, —CH₂CH₂CH₂CH₂—, or —(CH₂)ₓ—, R₃ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —CH₂—, —CH₂CH₂—, —CH₂CH₂CH₂—, —CH₂CH₂CH₂CH₂—, —CH₂CH₂CH CH₂CH₂— or —(CH₂)_{y}—; m, n, x and y are each an integer from 1 to 20; and [symbol] is the polymer backbone. In some embodiments, [symbol] may be a polysaccharide polymer backbone.

The zwitterionic polysaccharide polymer platform of claim 1 wherein said one or more zwitterionic side chains further comprises a zwitterionic moiety selected from the group consisting of 2-(di(methyl)(methylene)ammonio)acetate, 2-((methyl)(methylene)ammonio)acetate, 2-((methylene)ammonio)acetate 2-(bis(2-hydroxyethyl)(methylene)ammonio)acetate, 2-((2-hydroxyethyl)(methylene)(methyl)ammonio)acetate, 2-((2-hydroxyethyl)(methylene)ammonio)acetate, 3-((methyl)(methylene)ammonio) propanoate, 3-(bi(methyl)(methylene)ammonio) propanoate, 3-(bis(2-hydroxyethyl)(methylene)ammonio) propanoate, 3-((2-hydroxyethyl)(methylene)(methyl)ammonio) propanoate, 3-((2-hydroxyethyl)(methylene)ammonio) propanoate, and combinations and analogs/derivatives thereof.

In some embodiments, the zwitterionic side chains may have the formula:

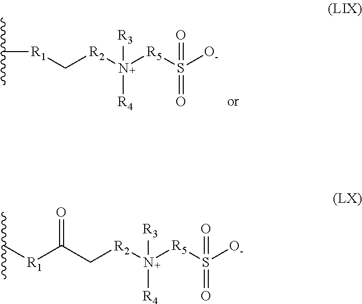

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂CH₂— or —(CH₂)ₓ—; R₃ is H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —CH₂CH₂—, —CH₂CH₂CH₂—, —CH₂CH₂CH₂CH₂—, —CH₂CH₂CH₂CH₂CH₂—, or —(CH₂)_{y}—; m, n, x and y are each an integer from 1 to 20; and [symbol] is the polymer backbone. In some embodiments, [symbol] may be a polysaccharide polymer backbone.

In some embodiments, the zwitterionic side chains may have the formula:

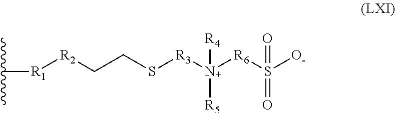

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂CH₂—, —(CH₂)ₓ—, —NHC(O)—, —NHC(O)CH₂—, —NHC(O)CH₂CH₂—, NHC(O)(CH₂)ₓ—, —OC(O)—, —OC(O)CH₂—, —OC(O)CH₂CH₂— or —OC(O)(CH₂)ₓ—; R₃ is —CH₂CH₂—, —CH₂CH₂CH₂—, —CH₂CH₂CH₂CH₂—, —CH₂CH₂CH₂CH₂CH₂—, —(CH₂)_{y}—; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₆ is —CH₂CH₂—, —CH₂CH₂CH₂—, —CH₂CH₂CH₂CH₂—, —CH₂CH₂CH₂CH₂CH₂—, or —(CH₂)_{z}—; m, n, x, y and z are each an integer from 1 to 20; and [symbol] is the polymer backbone. In some embodiments, [symbol] may be a polysaccharide polymer backbone.

In some embodiments, the zwitterionic side chains may have the formula:

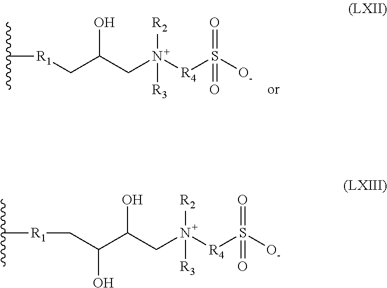

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O) (CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ, —O(CH₂CH₂O)ₘ, —(OCH₂CH₂)ₘ— or —(CH₂CH₂O)ₘ—; R₂ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₃ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH, R₄ is —CH₂—, —CH₂CH₂—, —CH₂CH₂CH₂—, —CH₂CH₂CH₂CH₂—, —CH₂CH₂CH₂CH₂CH₂— or —(CH₂)ₓ—; m, n and x are each an integer from 1 to 20; and [symbol] is the polymer backbone. In some embodiments, [symbol] may be a polysaccharide polymer backbone.

In some embodiments, the zwitterionic side chains may have the formula:

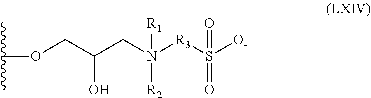

wherein R₁ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₂ are —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₃ is —CH₂—, —CH₂CH₂—, —CH₂CH₂CH₂—, —CH₂CH₂CH₂CH₂—, —CH₂CH₂CH₂CH₂CH₂— or —(CH₂)ₙ—; n is an integer from 1 to 20; and [symbol] is the polymer backbone. In some embodiments, [symbol] may be a polysaccharide polymer backbone.

In some embodiments, the zwitterionic side chains may have the formula:

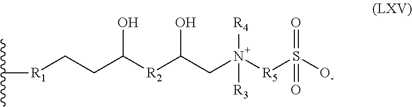

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂, CH₂CH₂—, —CH₂CH₂CH₂—, or —CH₂CH₂CH₂CH₂—, —(CH₂)ₓ—, R₃ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₄ are —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —CH₂—, —CH₂CH₂—, —CH₂CH₂CH₂—, —CH₂CH₂CH₂CH₂—, —CH₂CH₂CH₂CH₂CH₂— or —(CH₂)_{y}—; m, n, x and y are each an integer from 1 to 20; and [symbol] is the polymer backbone. In some embodiments, [symbol] may be a polysaccharide polymer backbone.

In some embodiments, the zwitterionic side chains may have the formula:

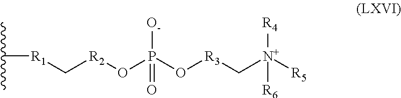

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O) (CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂CH₂—, —(CH₂)ₓ—; R₃ is —CH₂CH₂—, —CH₂CH₂CH₂—, —CH₂CH₂CH₂CH₂—, —CH₂CH₂CH₂CH₂CH₂—, —(CH₂)_{y}—; R₄, R₅ and R₆ are —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; m, n, x and y are each an integer from 1 to 20, and [symbol] is the polymer backbone. In some embodiments, [symbol] may be a polysaccharide polymer backbone.

As shown below, it has been found that zwitterionic carboxybetaines with hydroxyl group(s) can switch between a cationic lactone (ring) form (having antimicrobial properties) and the zwitterionic form (having antifouling properties) and the intramolecular hydrogen bonds will enhance the mechanical properties of the polymer or hydrogel in which it is used. Under neutral or basic condition, these materials are in zwitterionic forms that have ultralow-fouling properties; and under acidic conditions, they will automatically convert into their cationic charged (ring) forms, which have excellent antimicrobial ability. Bacteria can be trapped and killed through contact, then released under neutral or basic environment. This process is reversible (switchable) by simply changing the acidic/basic environment of the medium.

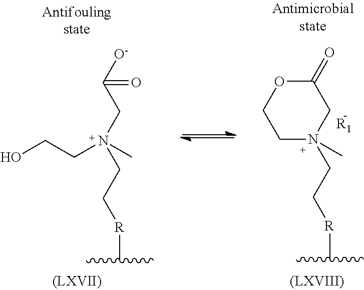

In some embodiments, the cationic ring form of the zwitterionic side chains may have the formula:

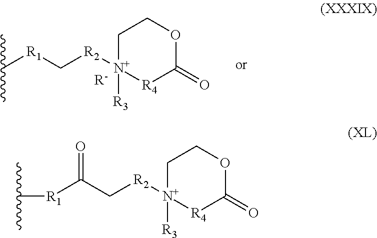

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O) (CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂—, or —(CH₂)ₓ₋₁—; R₃ is —H, —CH₃, —CH₂CH₃, —CH₂CH₂CH₃, —CH₂CH₂CH₂CH₃, CH₂CH₂OH, —CH₂CH₂CH₂OH, —CH₂CH₂CH₂CH₂OH, or —CH₂CH₂CH₂CH₂CH₂OH; R₄ is —CH₂—, —CH₂CH₂—, —CH₂CH₂CH₂—, —CH₂CH₂CH₂CH₂—, —CH₂CH₂CH₂CH₂CH₂—, —(CH₂)_{y}— or —(CH₂)_{y}O(CH₂)_{z}—; R⁻ is any organic or inorganic anion; m, n, x, y and z are each an integer from 1 to 20; and [symbol] is the polymer backbone. In some embodiments, [symbol] may be a polysaccharide polymer backbone.

In some embodiments, the cationic ring form of the zwitterionic side chains may have the formula:

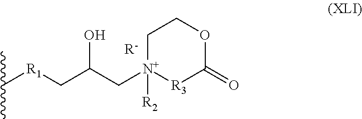

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —H, —CH₃, —CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₃ is —CH₂—, —CH₂CH₂—, —CH₂CH₂CH₂—, —CH₂CH₂CH₂CH₂—, —CH₂CH₂CH₂CH₂CH₂—, —(CH₂)_{y}— or —(CH₂)_{y}O(CH₂)_{z}—; R⁻ is any organic or inorganic anion; m, n, y and z are each an integer from 1 to 20; and [symbol] is the polymer backbone. In some embodiments, [symbol] may be a polysaccharide polymer backbone.

In some embodiments, the cationic ring form of the zwitterionic side chains may have the formula:

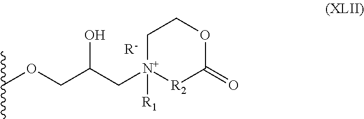

wherein R₁ is —H, —CH₃, —CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₂ is —CH₂—, —CH₂CH₂—, —CH₂CH₂CH₂—, —CH₂CH₂CH₂CH₂—, —CH₂CH₂CH₂CH₂CH₂—, —(CH₂)_{y}— or —(CH₂)_{y}O(CH₂)_{z}—; R⁻ is any organic or inorganic anion; y and z are each an integer from 1 to 20; and [symbol] is the polymer backbone. In some embodiments, [symbol] may be a polysaccharide polymer backbone.

In some embodiments, the cationic ring form of the zwitterionic side chains may have the formula:

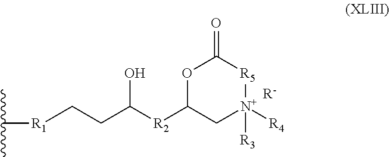

wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O) NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, —OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ, —O(CH₂CH₂O)ₘ, —(OCH₂CH₂)ₘ— or —(CH₂CH₂O)ₘ—; R₂ is —CH₂, CH₂CH₂—, —CH₂CH₂CH₂—, or —CH₂CH₂CH₂CH₂—; R₃ is —H, —CH₃, CH₂CH₃, —CH₂CH₂CH₃, —CH₂CH₂CH₃CH₃, —CH₂CH₂OH, —CH₂CH₂CH₂OH, —CH₂CH₂CH₂CH₂OH, or —CH₂CH₂CH₂CH₂CH₂OH; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —CH₂—, —CH₂CH₂—, —CH₂CH₂CH₂—, —CH₂CH₂CH₂CH₂—, or —CH₂CH₂CH₂CH₂CH₂—, —(CH₂)_{y}— or —(CH₂)_{y}O(CH₂)_{z}—; m, n, y and z are each an integer from 1 to 20; and [symbol] is the polymer backbone. In some embodiments, [symbol] may be a polysaccharide polymer backbone.

In some embodiments, the cationic ring form of the zwitterionic side chains may have the formula:

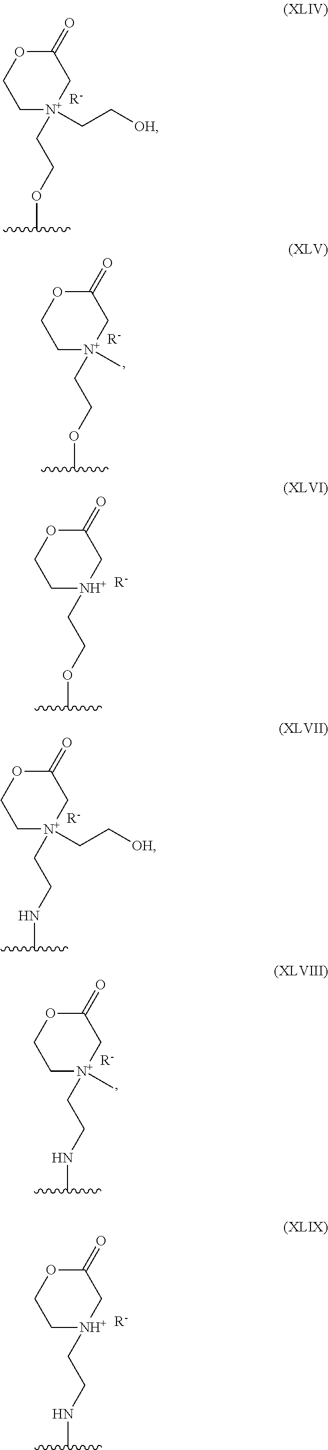

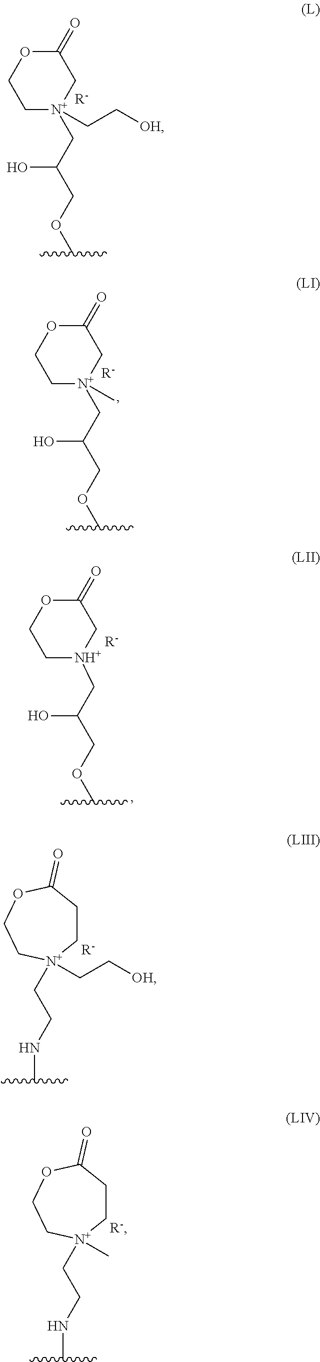

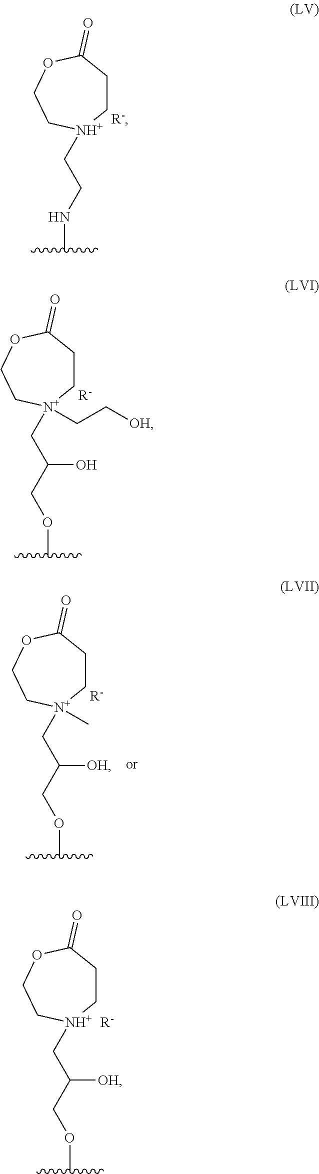

wherein R⁻ is any organic or inorganic anion and [symbol] is the polymer backbone. In some embodiments, [symbol] may be a polysaccharide polymer backbone.

In some embodiments, the zwitterionic composition of the present invention further comprises one or more crosslinking side chains. Like the zwitterionic side chains discussed above, the crosslinking side chains in these embodiments are bound at one end to the polymer backbone, but rather than zwitterionic functional groups, these side groups have a functional group capable of bonding either to another crosslinking side chain or to the polymer backbone to crosslink the polymer to form a polymer network. Suitable functional groups for use as part of the crosslinking side chains include, without limitation, methacrylate, acrylate, acrylamide and/or methacrylamide groups. In some embodiments, the zwitterionic composition of the present invention may be crosslinked to form a hydrogel.

It should be appreciated that in embodiments having a polysaccharide polymer backbone, the potential number of side chains that can be added to the polysaccharide polymer backbone will depend upon the particular polysaccharide and is limited to the total number of binding sites in each glucose (or other monosaccharide) segment of the polysaccharide polymer backbone. One glucose unit, for example, can have at most three zwitterionic or crosslinking side chains. In some of these embodiments, the degree of substitution for zwitterionic compositions may be from 0.1% to 300%. In some of these embodiments, the degree of substitution for zwitterionic compositions may be from 0.1% to 150%. In some of these embodiments, the degree of substitution for zwitterionic compositions may be from 0.1% to 100%. In some of these embodiments, the degree of substitution for zwitterionic compositions may be from 0.1% to 50%.

In some of these embodiments, degree of substitution for zwitterionic side chains in compositions according to embodiments of the present invention may be from 0.1% to 300%. In some embodiments, degree of substitution for zwitterionic side chains in compositions according to embodiments of the present invention may be from 0.1% to 50%. In some embodiments, degree of substitution for zwitterionic side chains in compositions according to embodiments of the present invention may be from 0.1% to 100%. In some embodiments, degree of substitution for zwitterionic side chains in compositions according to embodiments of the present invention may be from 0.1% to 150%. In some embodiments, degree of substitution for zwitterionic side chains in compositions according to embodiments of the present invention may be from 1% to 20%.

In some of these embodiments, degree of substitution for crosslinking side chains in compositions according to embodiments of the present invention may be from 0.1% to 300%. In some embodiments, degree of substitution for crosslinking side chains in compositions according to embodiments of the present invention may be from 0.1% to 50%. In some embodiments, degree of substitution for crosslinking side chains in compositions according to embodiments of the present invention may be from 0.1% to 100%. In some embodiments, degree of substitution for crosslinking side chains in compositions according to embodiments of the present invention may be from 0.1% to 150%. In some embodiments, degree of substitution for crosslinking side chains in compositions according to embodiments of the present invention may be from 1% to 20%.

The size of the zwitterionic polymer compositions according to embodiments of the present invention is not particularly limited and will depend upon the particular composition and its intended use. In some embodiments, the zwitterionic composition of the present invention may have a weight average molecular weight of from 300 to 10,000,000 daltons. In some embodiments, the zwitterionic composition of the present invention may have a weight average molecular weight of from 300 to 1,000,000 daltons. In some embodiments, the zwitterionic composition of the present invention may have a weight average molecular weight of from 300 to 100,000 daltons. In some embodiments, the zwitterionic composition of the present invention may have a weight average molecular weight of from 300 to 10,000 daltons. In some embodiments, the zwitterionic composition of the present invention may have a weight average molecular weight of from 4000 to 10,000 daltons.

As set forth above, embodiments of the present invention are also directed to a crosslinked polymer network formed from the zwitterionic polymer compositions described above. In some embodiments, the crosslinked polymer network of the present invention is a hydrogel. The cross-linked polymer allows for the formation of a three-dimensional network, which has a high level of hydration and similarity to tissues. Accordingly, these hydrogels are highly desired for a variety of biomedical applications, including such things as contact lens, tissue engineering scaffold, drug delivery coatings, wounding dressing, and medical device coatings. Among all hydrogels, polysaccharide hydrogels are particularly useful due to their biocompatible, biodegradability, low cost and design flexibility.

In some embodiments, the polymer networks and/or hydrogels of the present invention may be crosslinked by the one or more of the crosslinking side chains on the zwitterionic polymer compositions described above. As set forth above, these crosslinking side groups have a functional group capable of bonding either to another crosslinking side chain or to the polysaccharide polymer backbone to crosslink the polymer to form a polymer network. Suitable functional groups for use as part of the crosslinking side chains include, without limitation, methacrylate, acrylate, acrylamide and/or methacrylamide groups.

In some embodiments, the polymer networks and/or hydrogels of the present invention may be crosslinked by one or more multi-functional crosslinking compound. Suitable multi-functional compounds may include, without limitation, di(methyl)acrylates, multi-(methyl)acrylates, di(methyl)acrylamides, multi-(methyl) acrylamides, diepoxides, multi-epoxides, dithiols and multi-thiols, and combinations thereof. In some embodiments, the multi-functional crosslinking compounds may include, without limitation, carboxybetaine di(methyl)acrylate, carboxybetaine di(methyl)acrylamide, poly(ethylene glycol) di(methyl)acrylate, 1,3-propanedithiol, 1,4-butanedithiol, 1,3-butadiene diepoxide, and/or any combinations and/or analogs thereof.

In another aspect, embodiments of the present invention are directed to a method for forming the novel zwitterionic polysaccharide compositions discussed above. In some embodiments, CB-Dex and/or CB-Dex-MA may be synthesized via a one pot reaction as shown in Scheme 1, below.

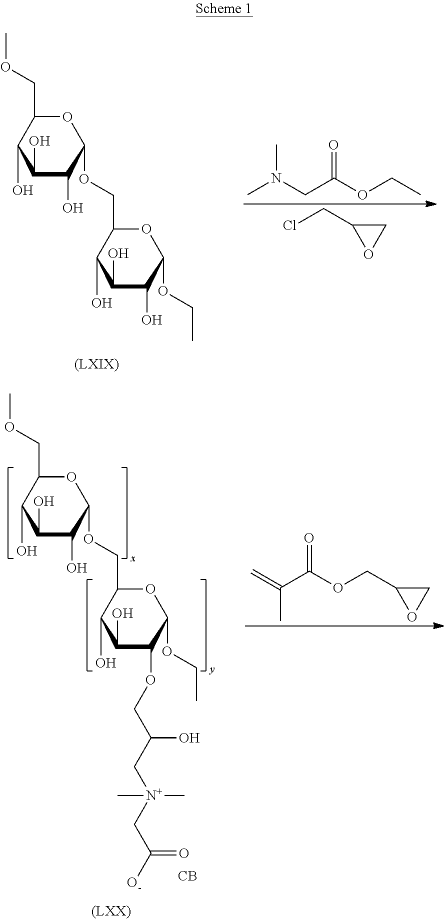

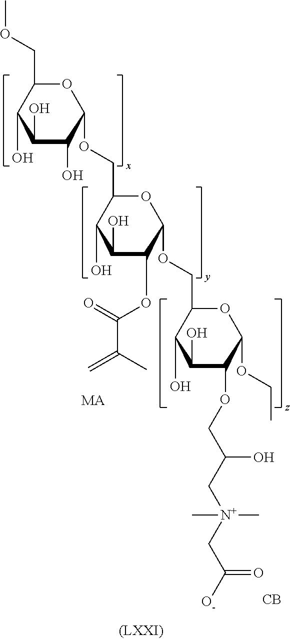

The method begins with selecting and/or preparing any one or more of the polymer backbone described above. As set forth above, these polymers should have one or more hydroxyl and/or amine groups available for bonding. A suitable polysaccharide polymer backbone, for example, may comprise saccharides such as dextran, cellulose, starch, glycosaminoglycans, mannan, dextrin, agar, agarose, alginic acid, alguronic acid, amylose, alpha glucan, amylopectin, beta-glucan, callose, carrageenan, cellodextrin, chitin, chitosan, chrysolaminarin, cyclodextrin, DEAE-sepharose, ficoll, fructan, fucoidan, galactoglucomannan, galactomannan, gellan gum, glucan, glucomannan, glucuronoxylan, glycocalyx, glycogen, hemicellulose, homopolysaccharide, hypromellose, inulin, laminarin, lentinan, levan polysaccharide, lichenin, mixed-linkage glucan, paramylon, pectic acid, pectin, pentastarch, phytoglycogen, pleuran, polydextrose, polysaccharide peptide, porphyran, pullulan, sepharose, xylan, xyloglucan, zymosan, hyaluronan, heparin, and/or combinations thereof.

In some embodiments, the polymer chain may comprise, without limitation, a (poly(vinyl alcohol), poly(2-hydroxyethyl methacrylate), poly(2-hydroxyethyl acrylate), poly(3-hydroxypropyl methacrylate), poly(3-hydroxypropyl acrylate), poly(4-hydroxybutyl methacrylate), poly(5-hydroxypentyl acrylate), poly(5-hydroxypentyl methacrylate), poly(4-hydroxybutyl acrylate), poly(N-(2-hydroxyethyl) methacrylamide), poly(N-(3-hydroxypropyl) methacrylamide), poly(N-(4-hydroxybutyl) methacrylamide), poly(N-(5-hydroxypentyl) methacrylamide), poly(N-(2-hydroxyethyl)acrylamide), poly(N-(3-hydroxypropyl) acrylamide), poly(N-(4-hydroxybutyl) acrylamide), poly(N-(5-hydroxypentyl) acrylamide), polyserine, poly lysine, polyamine, polyphenol, poly(1-glycerol methacrylate), poly(2,3-dihydrothieno[3,4-b][1,4]dioxin-2-yl) methanol), poly(2-(2,3-dihydrothieno[3,4-b][1,4]dioxin-2-yl) ethan-1-ol), poly(3-(2,3-dihydrothieno[3,4-b][1,4]dioxin-2-yl)propan-1-ol), poly(1-(2,3-dihydrothieno[3,4-b][1,4]dioxin-2-yl)propan-2-ol), poly(3-(2,3-dihydrothieno[3,4-b][1,4]dioxin-2-yl) propane-1,2-diol), poly(4-(2,3-dihydrothieno[3,4-b][1,4]dioxin-2-yl)butan-1-ol), poly(5-(2,3-dihydrothieno[3,4-b][1,4]dioxin-2-yl)pentan-1-ol), poly(5-(2,3-dihydrothieno[3,4-b][1,4]dioxin-2-yl)pentan-2-ol), poly(5-(2,3-dihydrothieno[3,4-b][1,4]dioxin-2-yl)pentane-2,3-diol), poly(1-(2,3-dihydrothieno[3,4-b][1,4]dioxin-2-yl)pentane-2,3,4-triol), poly(1-(2,3-dihydrothieno[3,4-b][1,4]dioxin-2-yl) ethan-1-ol), or poly(5-(2,3-dihydrothieno[3,4-b][1,4]dioxin-2-yl)pentan-1-ol)) having a hydroxyl or amine groups available for bonding.

The selected polymer backbone is then dissolved in a suitable solvent. The suitability of the solvent will, of course, depend upon the specific polymer selected, but one of ordinary skill in the art will be able to select a suitable solvent without undue experimentation. In some embodiments, the polymer backbone is a polysaccharide such as dextran and suitable solvents would include without limitation water, DMSO and DMF.

Next, the dissolved polymer backbone may be reacted with a zwitterionic compound in the presence of an organic or inorganic base to produce a zwitterionic polymer composition. The zwitterionic compound will have at least one functional group configured to bond to the polymer chain and at least one zwitterionic functional group. It should be appreciated that the zwitterionic compound may be any of the zwitterionic side chains discussed above, functionalized to bond to the polymer backbone. Further, the functional group or groups configured to bond to the polymer chain will, of course, depend upon the particular polymer backbone used but may include, without limitation, epoxide, ester, alkyl halide, acyl halide, carboxylate, sulfonate and aldehyde. In the embodiment shown above in Scheme 1, for example, a epoxide functional group on the zwitterionic compound was reacted with one of the available hydroxyl groups on the polysaccharide polymer backbone to bond the zwitterionic compound to the polymer backbone, thus forming a zwitterionic side chain as described above.

In some embodiments, the zwitterionic compound may be a zwitterionic betaine carrying one primary amine, secondary amine or tertiary amine, and a dibromoalkane, dichloroalkane, diepoxide, multi epoxide substituted alkane, multi halide substituted alkane, or a combination thereof. In some embodiments, the zwitterionic betaine comprises a carboxybetaine group. In some embodiments, the zwitterionic betaine may be 2-(di(methyl)(methylene)ammonio)acetate, 2-((methyl)(methylene)ammonio)acetate, 2-((methylene)ammonio)acetate 2-(bis(2-hydroxyethyl)(methylene)ammonio)acetate, 2-((2-hydroxyethyl)(methylene)(methyl)ammonio)acetate, 2-((2-hydroxyethyl)(methylene)ammonio)acetate, 3-((methyl)(methylene)ammonio) propanoate, 3-(bi(methyl)(methylene)ammonio) propanoate, 3-(bis(2-hydroxyethyl)(methylene)ammonio) propanoate, 3-((2-hydroxyethyl)(methylene)(methyl)ammonio) propanoate, 3-((2-hydroxyethyl)(methylene)ammonio) propanoate, and/or combinations or analogs/derivatives thereof.

As set forth above, the polymer backbone may then be reacted with a zwitterionic compound in the presence of an organic or inorganic base to produce a zwitterionic polymer composition. The suitability of the organic or inorganic base will, of course, depend upon the specific polymer and zwitterionic compound selected, but one of ordinary skill in the art will be able to select a suitable organic or inorganic base without undue experimentation. In some embodiments, for example, the polymer backbone is a polysaccharide such as dextran and the zwitterionic side chain is a carboxybetaine or glycine betaine. In these embodiments, suitable organic or inorganic base(s) may include without limitation sodium carbonate, pyridine, triethyl amine, Hünig's Base, 1,8-Diazabicyclo[5.4.0]undec-7-ene, Barton's Base and sodium hyzide.

In some embodiments, a polysaccharide polymer chain is reacted with an ester derivative of zwitterionic betaine that contains one tertiary amine, and dibromoalkane, dichloroalkane, diepoxide, multi halide substituted alkane, or multi halide epoxide substituted alkane to produce a cationic polysaccharide composition. In some embodiments, the zwitterionic compound may be a an ester derivative of zwitterionic betaine that contains a primary amine, secondary amine or tertiary amine, and a dibromoalkane, dichloroalkane, diepoxide, epichlorohydrin, a molecule with an acyl halide at one end and halide on the other end, a multi halide substituted alkane, a multi epoxide substituted alkane or a multi halide and epoxide substituted alkane. In these embodiments, the cationic polysaccharide is then hydrolyzed in suitable acidic or basic conditions to produce a zwitterionic polysaccharide composition. As one of ordinary skill in the art will appreciate, the selection of a suitable acid or a suitable base to hydrolyze the cationic polysaccharide will depend on the type of ester group on the cationic polysaccharide to be hydrolyzed. A methyl, ethyl, or propyl ester, for example, may be hydrolyzed under basic conditions to produce the zwitterionic polysaccharide composition. A butyl ester, on the other hand, may be hydrolyzed under acid conditions to produce the zwitterionic polysaccharide composition.

In some embodiments, a polysaccharide polymer backbone may be reacted with dimethylglycine and epichlorohydrin in the presence of an organic and inorganic base to produce a zwitterionic polysaccharide composition. In some embodiments, the polysaccharide polymer backbone may be reacted with 3-bromopropanoyl bromide or 2-bromoacetyl bromine and a zwitterionic betaine carrying a tertiary amine in the presence of an organic and inorganic base to produce a zwitterionic polysaccharide composition. In some embodiments, the polysaccharide polymer chain may be reacted with 3-bromopropanoyl bromide or 2-bromoacetyl bromine and ester derivative of zwitterionic betaine carrying a tertiary amine in the presence of an organic and inorganic base to produce a cationic polysaccharide composition. In these embodiments, the cationic polysaccharide composition may then be hydrolyzed in acidic or basic conditions to produce a zwitterionic polysaccharide composition.

As set forth above, crosslinking side chains may be added to polymer backbone in much the same way as the zwitterionic side chains discussed above. A crosslinking compound having at least one functional group configured to bond to the polymer chain and at least one crosslinking functional group is added to the polymer backbone and zwitterionic compound in the presence of an organic or inorganic base, thereby producing a zwitterionic polymer composition having crosslinking side chains. It should be appreciated that the crosslinking compound may be any of the crosslinking side chains discussed above, functionalized to bond to the polymer backbone. Further, the particular functional group or groups required to bond to the polymer backbone will, of course, depend upon the particular polymer backbone used but may include, without limitation, epoxide, ester, alkyl halide, acyl halide, carboxylate, sulfonate and aldehyde. In the embodiment shown above in Scheme 1, for example, an epoxide functional group on the crosslinking compound was reacted with one of the available hydroxyl groups on the polysaccharide polymer backbone to bond the crosslinking compound to the polymer backbone, thus forming a crosslinking side chain as described above. The crosslinking functional group may be any of the crosslinking groups discussed above.

In some embodiments, methacrylate crosslinking groups may be added to the zwitterionic polymer composition described above. In some embodiments, the methacrylate crosslinking groups may be added to a zwitterionic polysaccharide composition by adding glycidyl methacrylate to the polymer backbone and zwitterionic compound mixture described above.

The zwitterionic polymer composition may be purified according to any suitable method known in the art for that purpose. In some embodiments, zwitterionic polysaccharide compositions may be purified using a dialysis membrane or by precipitation of the zwitterionic polysaccharide composition into ethanol, ether, or another suitable organic solvent. The resulting zwitterionic polysaccharide composition may then be dried according to any suitable method known in the art for that purpose. In some embodiments, the zwitterionic polysaccharide composition may then be dried by lyophilizing. In some embodiments, the zwitterionic polysaccharide composition may then be dried by lyophilization, vacuum, or heat.

In some embodiments, the resulting polymer may be made into a polymer network or hydrogel. The polymer is first dissolved in a suitable solvent. One of ordinary skill in the art will be able to select a suitable solvent without undue experimentation. Suitable solvents included, without limitation, water, DMSO, THF, ethanol, methanol, or DMF.

Next, a free radical initiator is added and the solution is treated with ultraviolet light or heat to activate the free radical initiator and crosslink the polymer to form a hydrogel. The free radical initiator used is not particularly limited and any free radical initiator and/or initiation process known in the art for this purpose may be used.

In some embodiments, the radical initiator may be, without limitation an azo compound, an inorganic peroxide, an organic peroxide, 2-hydroxy-4′-(2-hydroxyethoxy)-2-methylpropiophenone, 4,4′-azobis(4-cyanovaleric acid), 1,1′-azobis(cyclohexanecarbonitrile), 2,2′-azobis(2-methylpropionitrile), 2,2′-azobis[2-(2-imidazolin-2-yl)propane]dihydrochloride, 2,2′-azobis[2-(2-imidazolin-2-yl)propane]disulfate dehydrate, 2,2′-azobis(2-methylpropionamidine)dihydrochloride or a combination thereof. One of ordinary skill in the art will understand how to activate the free radical initiator used without undue experimentation.

### EXPERIMENTAL

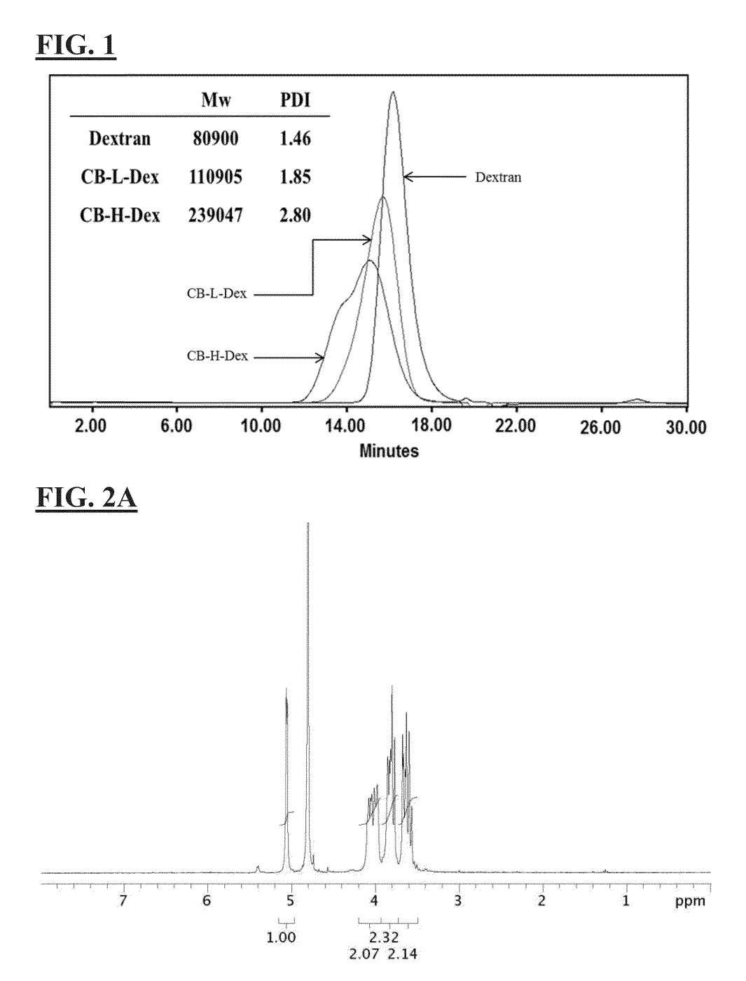

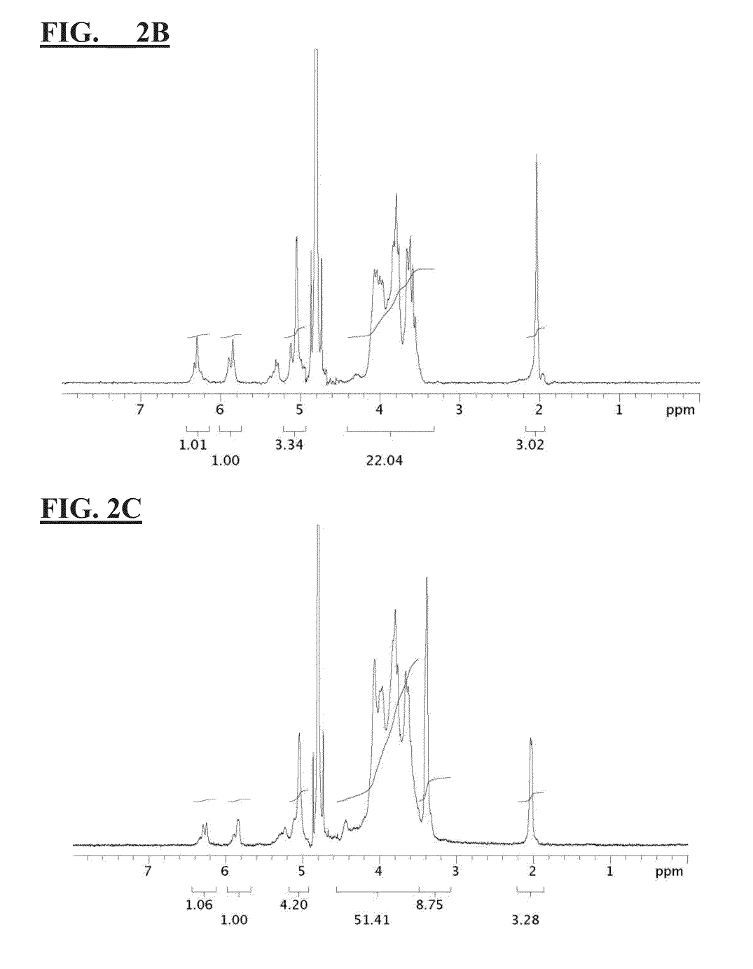

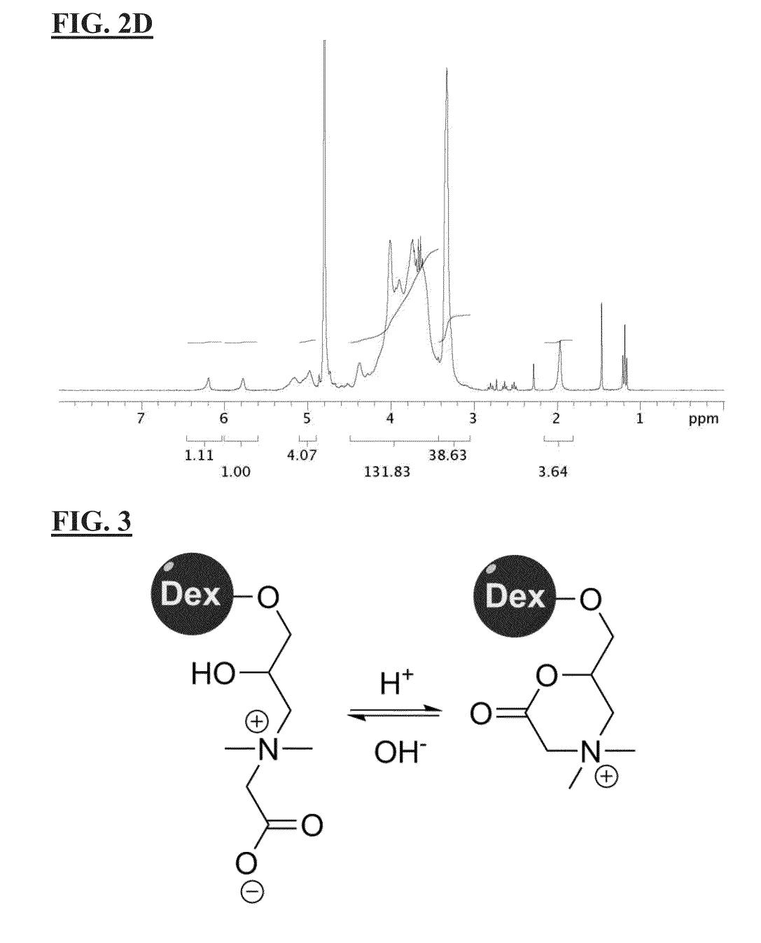

As shown in Scheme 1 and discussed above, CB-Dex may be synthesized via a one pot reaction. The molecular weight and the degree of substitution were characterized by GPC (FIG. 1) and ¹H NMR spectroscopy FIG. 2A_D (FIG. S2), respectively. Zwitterionic CB side chains were introduced onto dextran backbone. GPC results show a decrease in retention time as the substitution ratio increases from unmodified dextran, CB-L-Dex, to CB-H-Dex. Especially for CB-H-Dex polymer, as expected, after repeated zwitteration steps with the higher ratio of substitution reactant, the molecular weight of dextran increased from 81 kD to 240 kD. Based on the calculation from NMR data, the degree of substitution reached 158% for CB-H-Dex which is in good agreement with GPC results.

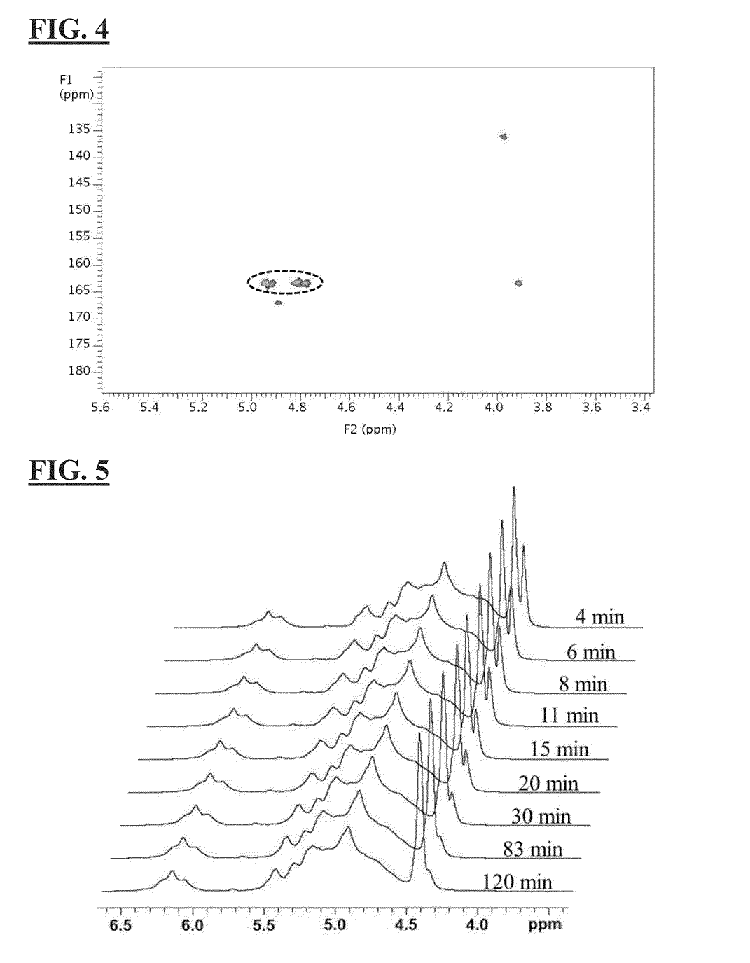

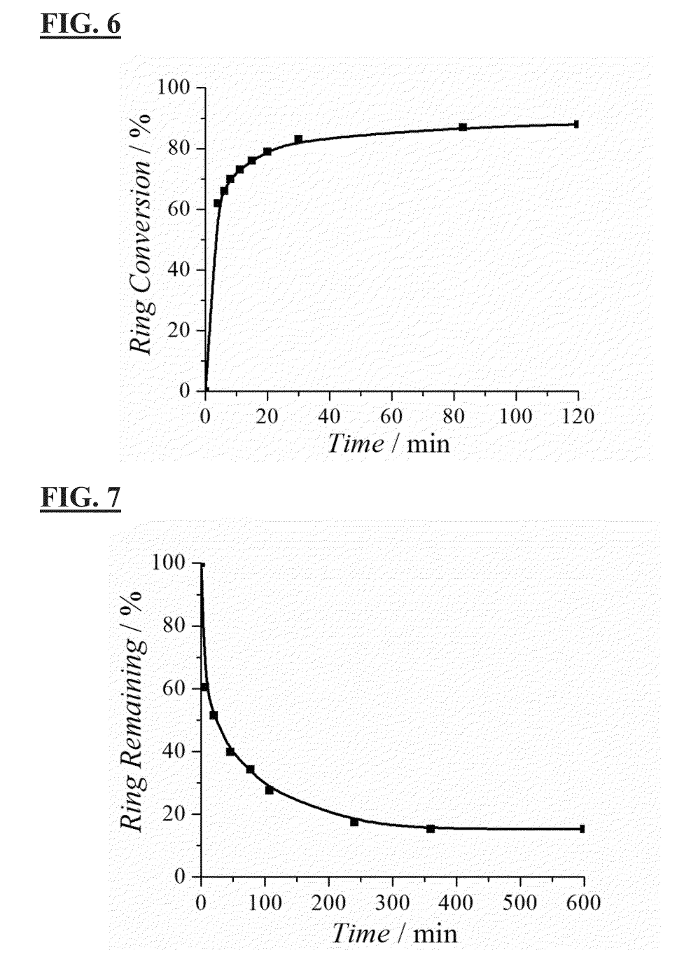

Further, it has been found that the hydroxy and carboxylate groups of these CB-Dex polymers can undergo cyclization to form cationic lactone ring structure under acidic condition, while the ring opens under neutral or basic conditions. The material can, therefore, switch between two different states (zwitterionic and cationic ring form) and achieve two different functions (antifouling and antimicrobial). (See FIG. 3). To demonstrate this aspect of the invention, a heteronuclear multiple-bond correlation (gHMBC) 2D-NMR spectrum, which provides two- and three-bond correlations between ¹H and ¹³C, was used to verify the ring structure formation of CB-Dex (See FIG. 4) in TFA-d. These tests show that CB side chains of dextran formed six-membered lactone ring structure and showed well resolved correlations in the 2D NMR spectrum. The crosspeak in dotted circle shows the two bond correlation between the resonances of methylene proton adjacent to carboxylate and the resonances of carbonyl carbon. It changes from a single peak into a doublet of doublet as the evidence of ring structure formation. ¹H NMR data was collected at different time points to study the dynamic ring formation process. (See, FIG. 5). The conversion ratio was calculated based on the integral ratio from the methyl (—CH₃) protons in each form. As shown in FIG. 6, about of CB-Dex side chains were converted into the six-membered ring form in TFA within 2 hours.

The ring opening kinetics (FIG. 7) of zwitterionic polysaccharide in its cationic form were further studied by dissolving polymer in their cationic forms in pure D₂O. Calculations were performed with the same method as for ring formation above, and the final conversion was 86% for CB-Dex in 10 hours. Unmodified dextran was used as a control material. No ring formation was observed with unmodified dextran under acidic conditions.

It is know that formation of a biofilm will cause a drop in local pH, both in vitro and in vivo and switchable antimicrobial/antifouling materials have been developed that can switch to an antimicrobial material from a antifouling zwitterionic material under acidic conditions. See Cao, B.; Li, L. L.; Tang, Q.; Cheng, G., “The impact of structure on elasticity, switchability, stability and functionality of an all-in-one carboxybetaine elastomer.” Biomaterials 2013, 34 (31), 7592-7600 and Cao, B.; Tang, Q.; Li, L. L.; Humble, J.; Wu, H.; Liu, L.; Cheng, G. “Switchable antimicrobial and antifouling hydrogels with enhanced mechanical properties.” Adv. Healthcare Mater. 2013, 2, 1096-1102, the disclosures of which are incorporated herein by reference in their entirety. These switchable antimicrobial/antifouling materials have been shown to kill 99.5% of attached bacteria in their cationic antimicrobial form and then release 95% of killed cells at their zwitterionic antifouling state. It is expected that switchable zwitterionic polymers described herein would have same antimicrobial/antifouling functions.

As set forth above, protein fouling on the surfaces of devices in the complex medium is known to cause the failure, affect the service life and/or decrease the sensitivity of implanted devices. One of the main reasons for the underperformance of known polysaccharides is their unsatisfactory capability to resist protein adsorption from the complex medium. It has been found that zwitterionic CB side chains can dramatically reduce non-specific protein adsorption on polysaccharide materials. To demonstrate this aspect of the invention, protein adsorption studies were carried out on the hydrogel surfaces and visualized with fluorescence microscopy. Three types of samples were compared, CB-H-Dex, CB-L-Dex and Dex-MA. Hydrogels of Dex-MA without CB side chains were used as controls in the study.

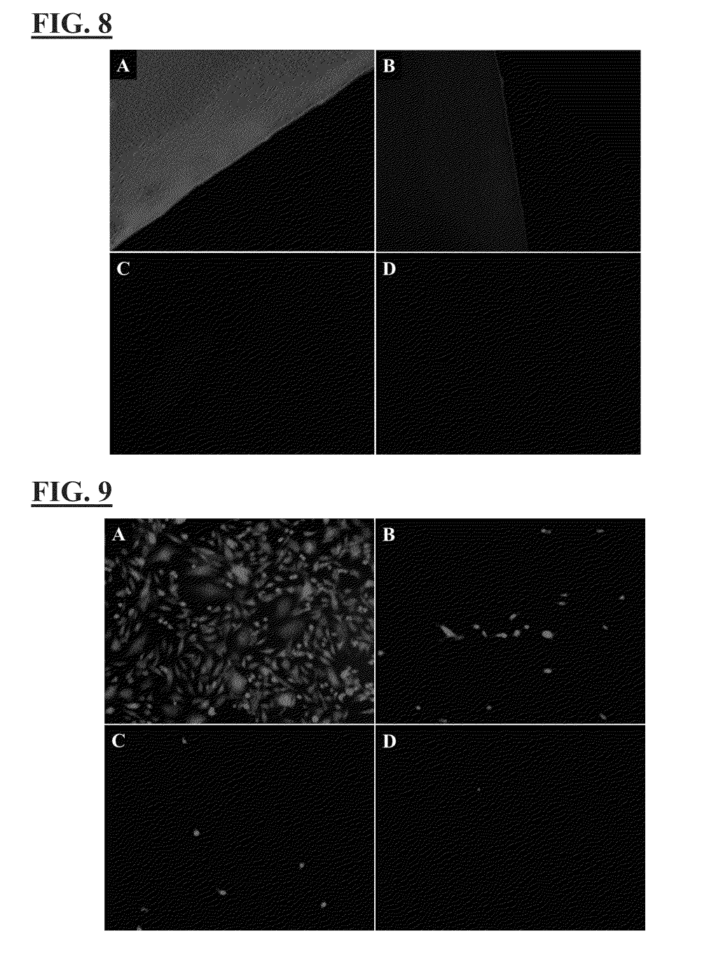

As shown in FIGS. 8A-D, among all samples tested, Dex-MA hydrogels show the highest fluorescence intensity, which indicated the highest protein adsorption. The one with highest CB ratio (CB-H-Dex) shows the lowest amount of adsorbed protein, while dextran hydrogel with low CB substitution (CB-L-Dex) show the medium fluorescence intensity. Image-J software was utilized to quantify the fluorescence intensity values of each image. Compared to Dex-MA hydrogel, CB-L-Dex and CB-H-Dex hydrogels showed 26.6% and 4.6% of fluorescent signal intensities, respectively. (See, Table 1). The fact that hydrogel samples with different degrees of CB substitution show similar equilibrium water content (See Table 1), indicates that there is no direct correlation between hydrogel water content and the degree of CB substitution and, therefore, that the difference in protein adsorption on hydrogel surfaces was not because of water content but the CB functional groups.

TABLE 1
Protein adsorption (quantified by ImageJ) and
equilibrium water content of hydrogels (average of 3 samples).

| | Dex-MA | CB-L-Dex | CB-H-Dex |
|---|---|---|---|
| Protein Adsorption (FL-Intensity) | 100% | 26.6% | 4.6% |
| Equilibrium Water Content | 86.4% | 86.8% | 82.3% |

As discussed above, for implantable materials, protein adsorption on surfaces from blood and body fluid can trigger the cell attachment, which can further trigger foreign body reaction and lead to chronic inflammation or isolation of the implanted materials. As will be appreciated by those of skill in the art, the foreign body reaction can be minimized if the surface implanted materials can effectively resist protein adsorption and cell attachment. To demonstrate the antifouling properties of CB-Dex hydrogels according to one or more embodiment of the present invention, cell adhesion studies were performed with bovine aortic endothelium cells (BAECs). After incubated at 37° C. for 24 hours, the control tissue culture polystyrene (TCPS) surface turned out full coverage of BAECs but the surface of the CB-H-Dex showed almost no cell adhesion. (See, FIGS. 9A-D). These results demonstrated the zwitterionic CB-Dex hydrogels of embodiments of the present invention may be highly resist cell adhesion. It is believed that these CB-H-Dex coatings can prolong the service life of implanted materials by minimizing protein adsorption and cell attachment.

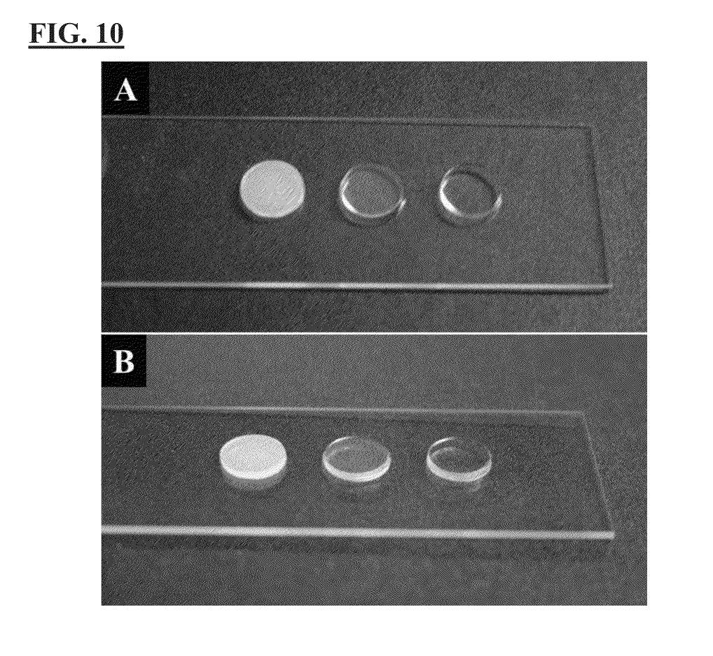

In addition, it has been found that the optical clarity of dextran hydrogels according to embodiments of the present invention differ dramatically with the degree of CB substitution. FIGS. 10A-B are digital images of dextran hydrogels showing a top view (FIG. 10A) and a side view (FIG. 10A) of (from left to right): Dex-MA, CB-L-Dex, and CB-H-Dex. Dex-MA hydrogel (FIGS. 10A-B, furthest left) shows white color and is mostly opaque. It has been found that degree of CB substitution increases, the hydrogel becomes less opaque and in at least one embodiment the hydrogel becomes translucent when the degree of CB substitution reaches 35%. Accordingly, the CB-H-Dex hydrogel with high CB content is completely transparent. It is important to have an optically transparent clear material to meet the needs of optical sensor or devices, such as contact lens, optical sensors, coatings, etc., which work in the complex fouling environments. Since the water content of all three samples was similar, it is believed that the difference in the optical transparency of the hydrogels tested was not caused by any differences in the water content. While not being bound by theory, it is believed that ionic interaction between the zwitterionic domains with water trapped inside of hydrogel network increase the solubility of dextran such that the matrix becomes more transparent with the increase of CB substitution.

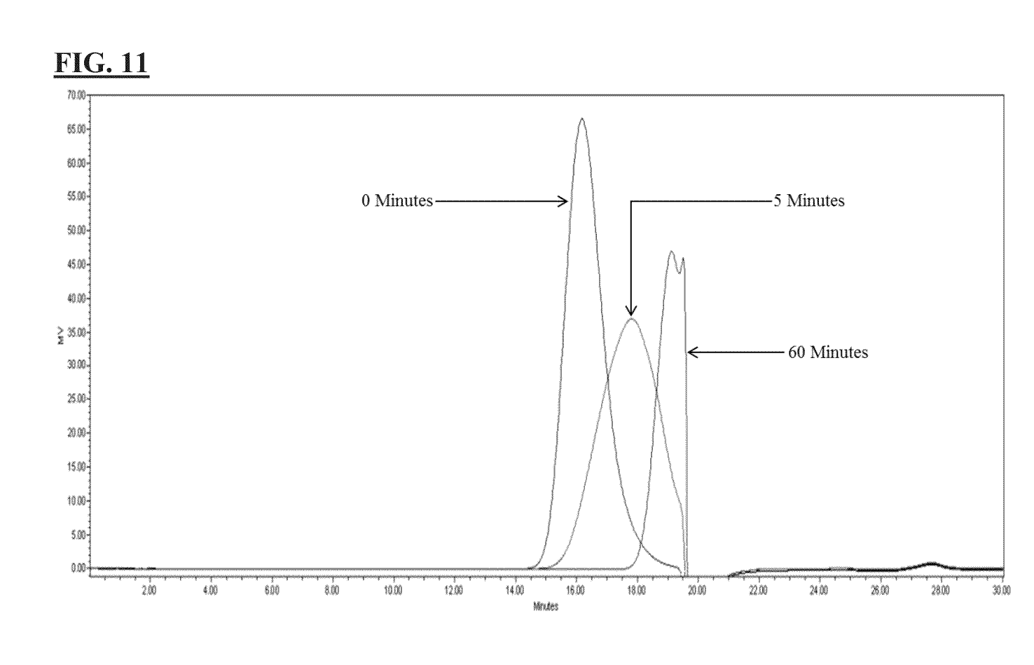

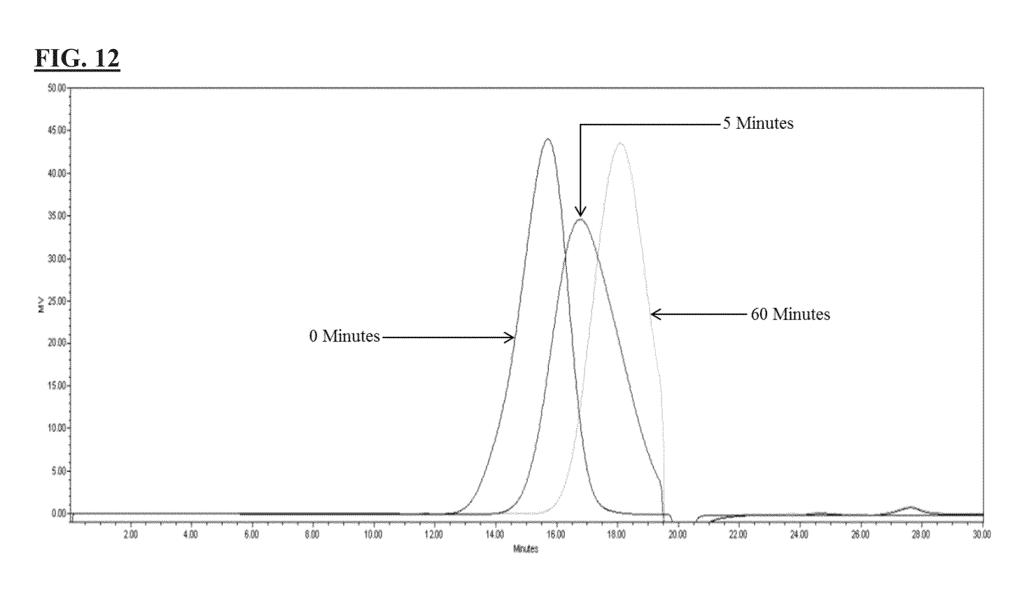

In some embodiments, the CB Dextran hydrogels and polymers of the present invention have better stability and are less easily degraded than dextran without CB modifications. To demonstrate this, enzyme degradation studies of dextran and CB-L-Dex were carried out under identical conditions. The GPC results (FIGS. 11, 12) show that dextran without CB modifications degraded faster than CB-Dextran under the same conditions. However, the major reason here must not be insolubility, since CB units can definitely increase the solubility of polymer. Instead, the charge distribution of zwitterionic structure may stabilize the ring from deformation to a certain extent.

It has been demonstrated that zwitteration of dextran can be simply achieved via one pot reaction. Zwitterionic CB-Dex of embodiments of the present invention show superior antifouling property, enhanced optical transparency, as well as switchability between cationic and zwitterionic states. The properties of zwitterionic polysaccharides can be tuned through controlling the ratio of substitution. Unique properties from two distinct materials (polysaccharides and zwitterionic materials) were integrated into one material without sacrificing any properties. To the best of our knowledge, such facile zwitteration method has not been reported. All the advantages, including: simple one pot synthetic pathway in aqueous solution, switchability of two distinct functions, low cost and natural abundance of raw materials, relatively easy purification steps, together with quantitative high yield make this a very promising zwitteration pathway of nature products. Through this study, we also developed an understanding of basic properties of zwitterionic polysaccharides, and this platform can be adapted to a range of applications (e.g. biosensing, drug delivery, tissue engineering, implantable medical devices, and bioseparation).

In light of the foregoing, it should be appreciated that the present invention significantly advances the art by providing a switchable antimicrobial and antifouling carboxybetaine-based hydrogels with enhanced mechanical properties that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### EXAMPLES

The following examples are offered to more fully illustrate the invention, but are not to be construed as limiting the scope thereof. Further, while some of examples may include conclusions about the way the invention may function, the inventor do not intend to be bound by those conclusions, but put them forth only as possible explanations. Moreover, unless noted by use of past tense, presentation of an example does not imply that an experiment or procedure was, or was not, conducted, or that results were, or were not actually obtained. Efforts have been made to ensure accuracy with respect to numbers used (e.g., amounts, temperature), but some experimental errors and deviations may be present. Unless indicated otherwise, parts are parts by weight, molecular weight is weight average molecular weight, temperature is in degrees Centigrade, and pressure is at or near atmospheric.

Dextran (70 k), N,N-dimethylglycine ethyl ester, epichlorohydrin, sodium hydroxide, glycidyl methacrylate, trifluoroacetic acid-d (TFA-d), 2-Hydroxy-4′-(2-hydroxyethoxy)-2-methylpropiophenone, cellulose dialysis membrane (14 k cut-off), phosphate-buffered saline (PBS), fluorescein isothiocyanate (FITC) and human fibrinogen (Fg), fluorescein diacetate used as cell viability stain were purchased from Sigma-Aldrich (St. Louis, Mo.). Bovine aorta endothelial cells (BAECs) were purchased from American Type Culture Collection (Rockville, Md.). Dulbecco's Modified Eagle's Medium (DMEM) was purchased from Invitrogen. Dextranase was purchased from MP Biomedicals (Solon, Ohio). Water used in all experiments was purified using a Millipore Milli-Q Direct 8 Ultrapure Water system (Billerica, Mass.).

### Example 1

### Synthesis and Characterization of CB-Functionalized Dextran (CB-Dex)

4.9 mL (33.7 mmole) of N,N-Dimethylglycine ethyl ester was dissolved and hydrolyzed in 15 mL of NaOH solution containing 1.35 g of NaOH (33.7 mmole) at 50° C. for overnight. After the removal of the byproduct (ethanol) with rotary evaporation, the solution was mixed with 1 g of dextran (70 k) (6.13 mmole of glucose unit) in water, followed by the addition of 2.5 mL of epichlorohydrin (30.6 mmole). The mixture was stirred at 55° C. for 2 days. After the reaction, the product was purified by cellulose dialysis membrane (14 k cut off) and lyophilized to obtain CB dextran (CB-L-Dex). A higher degree of CB substitution was achieved by repeating the addition reaction with another 10 equivalent of reactant. Methacrylate (MA) as crosslinking groups was grafted onto the polymer backbone via the treatment of glycidyl methacrylate, the disclosure of which is hereby incorporated by reference in its entirety. Three MA modified dextran derivatives, with different degree of CB substituent, from 0% (Dex-MA), 35% (CB-L-Dex-MA), to 158% (CB-H-Dex-MA) were synthesized. All samples were kept at a similar MA ratio of around 25% (one MA unit per four glucose units). The degree of CB substitution was assessed by ¹H NMR by integrating the peaks at 5.1 ppm (anomeric proton of dextran) against 4.8 ppm (CH₃ of CB) (Varian 300 MHz). (See FIG. 2) The molecular weights of dextran derivatives (dissolved in running buffer, concentration: 5 mg/mL) were determined by a Waters 1515 gel permeation chromatography (GPC) system equipped with a 2414 refractive index detector (Milford, Mass., USA) and two analytical Agilent PL aquagel-OH MIXED-M columns (300 mm×7.8 mm), using 0.01 M NaH₂PO₄ and 0.3 M NaNO₃ as a mobile phase at a flow rate of 1 mL/min at room temperature. Dextran standards (Fluka, Switzerland) in the molecular range of 1-356 kDa were used as calibration standards.

### Example 2

### Preparation of CB-Functionalized Dextran Hydrogels (CB-Dex)

Dextran hydrogels were prepared via photopolymerization as follows. All samples were dissolved at the concentration of 2 M (regarding to glucose unit) with 0.5 weight percent of photoinitiator, 2-Hydroxy-4′-(2-hydroxyethoxy)-2-methylpropiophenone, in water. Then the solution was transferred into a mold made of two quartz slides separated by an 1 mm thick polytetrafluoroethylene (PTFE) spacer and polymerized under UV (362 nm) for 1 hour. The gel was equilibrated in water for 3 days. The wet weight of the hydrogel sample was measured after the removal of excess water. Dry weight of each hydrogel was recorded after the sample was freeze-dried for 48 hours. The water content of the hydrogels (as a percent) were calculated by (Wet weight−Dry weight)/Wet weight×100.

### Example 3

### Protein Adsorption Study of CB-Functionalized Dextran Hydrogel (CB-Dex)

To demonstrate this aspect of the invention, protein adsorption studies were carried out on the hydrogel surfaces and visualized with fluorescence microscopy. Three types of samples were compared, CB-H-Dex, CB-L-Dex and Dex-MA. Hydrogels of Dex-MA without CB side chains were used as controls in the study.

After reaching equilibrium in PBS, Dex-MA, CB-L-Dex-MA and CB-H-Dex-MA hydrogels were cut into discs with a biophysical punch (8 mm in diameter and 1 mm thick), washed thoroughly with deionized (DI) water and transferred into a sterile 24-well plate. 1 mL of FITC-labeled fibrinogen (FITC-Fg) solution (0.1 mg/mL) was added into each well. All samples were immersed in the solution for 30 minutes to allow protein adsorption on hydrogel surfaces. To remove loosely adsorbed proteins on sample surfaces, hydrogel samples were rinsed with phosphate buffered saline (PBS) three times. Protein adsorption on hydrogel surface was visualized with an Olympus IX81 fluorescent microscopy (Olympus, Japan) with 40× objective lens through FITC filter at a fixed exposure time for all samples, so the different protein adsorption will lead to different fluorescent intensity on images. To make sure that all samples were focused on the same plane, pictures were taken on the edge of hydrogel samples. ImageJ software was used to quantify the fluorescent intensity of each sample.

Among the samples tested, the Dex-MA hydrogels showed the highest fluorescence intensity, which indicates the highest protein adsorption. (See FIGS. 8A-D). The sample with highest CB ratio (CB-H-Dex) shows the lowest amount of adsorbed protein, while dextran hydrogel with low CB substitution (CB-L-Dex) showed a medium level of fluorescence intensity. Image-J software was utilized to quantify the fluorescence intensity values of each image. Compared to Dex-MA hydrogel, CB-L-Dex and CB-H-Dex hydrogels showed 26.6% and 4.6% of fluorescent signal intensities, respectively. (See Table. 1, above).

### Example 4

### Cell Adhesion Study for CB-Functionalized Dextran Hydrogels (CB-Dex)

BAECs were chosen to study cell adhesion on hydrogel surfaces, since their attachment on a surface depend on the protein adsorption on the surface. After the CB-Dex hydrogels made as described above were equilibrated in water, bovine aortic endothelium cells (BAECs) were seeded on different hydrogel substrates at 8×10⁴ cells/well with serum medium consisting of DMEM, 10% fetal bovine serum (FBS), and 1% penicillin-streptomycin and kept in an incubator with 5% CO₂ at 37° C. for 24 hours. Tissue culture polystyrene (TCPS) plate was used as positive fouling control surface. Fluorescein diacetate was used to stain cells. Surface cell coverage and cell morphology was visualized with the same fluorescence microscope with the FITC filter. After incubated at 37° C. for 24 hours, the control tissue culture polystyrene (TCPS) surface turned out full coverage of BAECs. However, there was almost no cell adhesion on CB-H-Dex surface (FIGS. 9A-D).

### Example 5

### Enzymatic Degradation Study for CB-Functionalized Dextran Hydrogels (CB-Dex)

Dextran and CB-L-Dex were dissolved separately in sodium acetate buffer (5 mM, pH 5.5) at 5 mg/mL and degraded with dextranase (0.1 U/ml) with stirring at room temperature. For each material, 300 μL of samples were taken from the reaction mixture at 5 minutes and 1 hour respectively during the degradation reaction, filtered with a 0.2 μm membrane and characterized with GPC. Enzyme degradation study of dextran (FIG. 11) and CB-L-Dex (FIG. 12) was carried out under the same condition. The GPC results (FIG. 11) are consistent with earlier investigations that chemical modifications will decrease the rate of enzymatic hydrolysis. It shows that dextran without CB modifications degraded relatively faster compared to CB-Dextran under the same conditions.

1. A zwitterionic composition having excellent anti-fouling, switchability, antimicrobial and optical properties comprising:
a polymer backbone; and
one or more zwitterionic moieties chemically bonded to said polymer backbone, said zwitterionic moieties further comprising a carboxybetaine group.

2. (canceled)

3. (canceled)

4. The zwitterionic composition of claim 1 wherein polymer backbone comprises a polysaccharide polymer backbone.

5. (canceled)

6. (canceled)

7. (canceled)

8. (canceled)

9. The zwitterionic composition of claim 1 wherein said one or more zwitterionic moieties have a formula selected from the group consisting of: 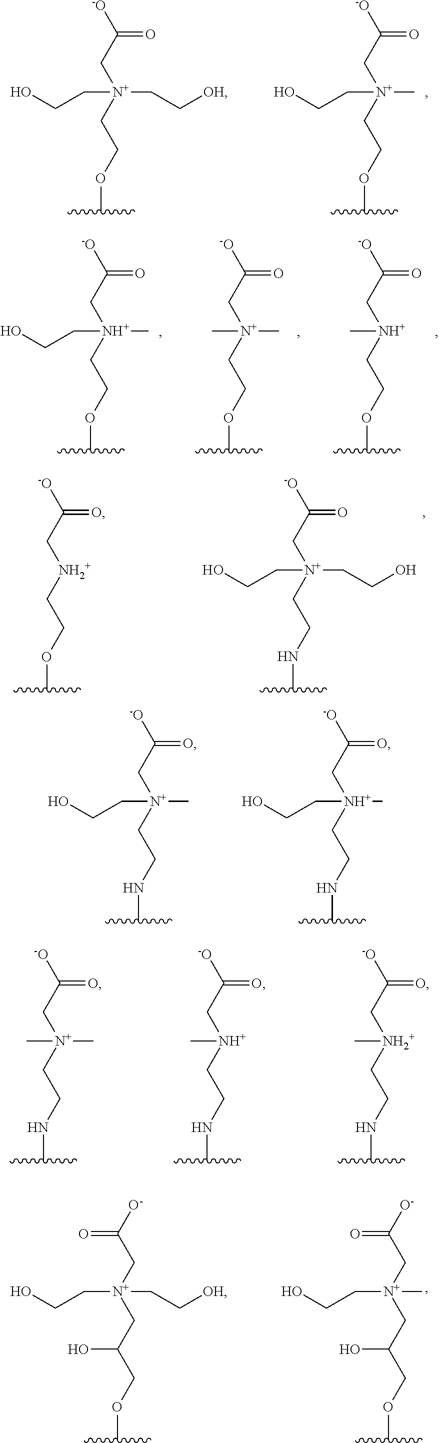 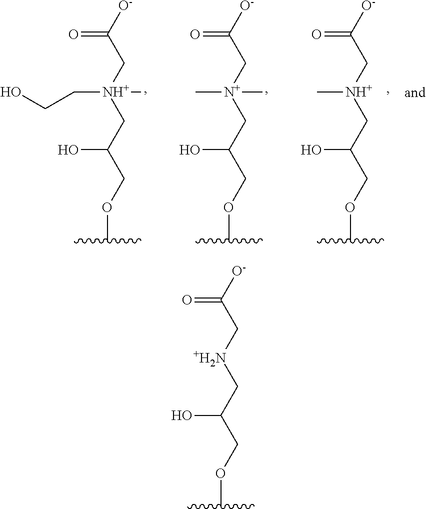
wherein [symbol] is the polymer backbone.

10. The zwitterionic composition of claim 1 wherein said one or more zwitterionic moieties have a formula selected from: 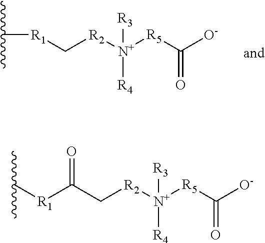
wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ, —NHC(O)(CH₂)ₘC(O)NH—, —OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂CH₂—, or —(CH₂)ₓ—; R₃ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH or —CH₂CH₂CH₂CH₂CH₂OH; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —CH₂—, —CH₂CH₂—, —CH₂CH₂CH₂—, —CH₂CH₂CH₂CH₂—, —CH₂CH₂CH₂CH₂CH₂—, or —(CH₂)_{y}; m, n, x and y are each an integer from 1 to 20; and [symbol] is the polymer backbone.

11. The zwitterionic composition of claim 1 wherein said one or more zwitterionic moieties has the formula: 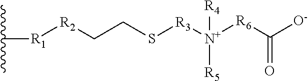
wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, —OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂CH₂—, —(CH₂)ₓ—, —NHC(O)—, —C(O)NH—, —NHC(O)O—, —NHC(O)CH₂—, —NHC(O)CH₂CH₂—, NHC(O)(CH₂)ₓ—, NHC(O)O(CH₂)ₓ—, OC(O)NH(CH₂)ₓ, OC(O)NH(CH₂)ₓ—, —OC(O)—, —OC(O)CH₂—, —OC(O)CH₂CH₂— or —OC(O)(CH₂)ₓ—; R₃ is —CH₂CH₂—, —CH₂CH₂CH₂—, —CH₂CH₂CH₂CH₂—, —CH₂CH₂CH₂CH₂CH₂—, or —(CH₂)_{y}—; R₄ is —H, —CH₃, —CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₆ is —CH₂—, —CH₂CH₂—, —CH₂CH₂CH₂—, —CH₂CH₂CH₂CH₂—, —CH₂CH₂CH₂CH₂CH₂— or —(CH₂)_{z}—; m, n, x, y and z are each an integer from 1 to 20; and [symbol] is the polymer backbone.

12. The zwitterionic composition of claim 1 wherein said one or more zwitterionic moieties have the formula: 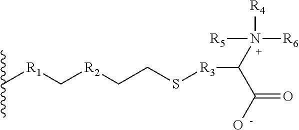
wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, —OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂CH₂—, —(CH₂)ₓ—, —NHC(O)—, —NHC(O)CH₂—, —NHC(O)CH₂CH₂—, —NHC(O)(CH₂)ₓ—, —OC(O)—, —OC(O)CH₂—, —OC(O)CH₂CH₂— or —OC(O)(CH₂)ₓ—; R₃ is —CH₂CH₂—, —CH₂CH₂CH₂—, —CH₂CH₂CH₂CH₂—, —CH₂CH₂CH₂CH₂CH₂— or —(CH₂)_{y}—; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH or —CH₂CH₂CH₂CH₂CH₂OH; R₆ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; m, n, x and y are each an integer from 1 to 20; and [symbol] is the polymer backbone.

13. The zwitterionic composition of claim 1 wherein said one or more zwitterionic moieties have the formula: 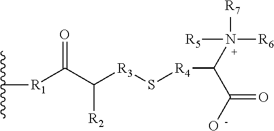
wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —C(O)NH(CH₂)—, —NHC(O)(CH₂), —(CH₂)ₘC(O)NH(CH₂)ₙ—, —NHC(O)(CH₂)ₘC(O)NH—, —OC(O)(CH₂)ₘC(O)NH—, —O(CH₂)ₘC(O)NH—, —NHC(O)(CH₂)ₘO—, —CH₂C(O)O—, —OC(O)CH₂—, —OC(O)CH₂CH—, —OC(O)(CH₂)ₘ—, —OC(O)(CH₂)ₘO—, —(CH₂)ₘOC(O)(CH₂)ₙ—, —(CH₂)ₘC(O)O(CH₂)ₙ—, —C(O)O(CH₂)ₙ—, —OC(O)(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂—CH₂CH₃, or —CH₂CH₂CH₃; R₃ is —CH₂—, —CH₂CH₂—, —CH₂CH₂CH₂—, —CH₂CH₂CH₂CH₂—, —CH₂CH₂CH₂CH₂CH₂— or —(CH₂)ₓ—; R₄ is —CH₂CH₂—, —CH₂CH₂CH₂—, —CH₂CH₂CH₂CH₂—, —CH₂CH₂CH₂CH₂CH₂—, or —(CH₂)_{y}—; R₅ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₆ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH or —CH₂CH₂CH₂CH₂CH₂OH; R₇ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH or —CH₂CH₂CH₂CH₂CH₂OH; m, n, x and y are each an integer from 1 to 20; and [symbol] is the polymer backbone.

14. The zwitterionic composition of claim 1 wherein said one or more zwitterionic moieties have a formula selected from: 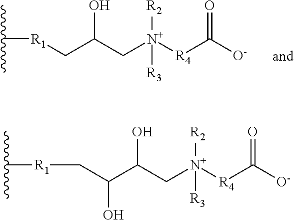
wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O)NH—, —(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, —OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₃ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH, R₄ is —CH₂—, —CH₂CH₂—, —CH₂CH₂CH₂—, —CH₂CH₂CH₂CH₂—, —CH₂CH₂CH₂CH₂CH₂— or —(CH₂)ₓ—; m, n and x are each an integer from 1 to 20; and [symbol] is the polymer backbone.

15. The zwitterionic composition of claim 1 wherein said one or more zwitterionic moieties have the formula: 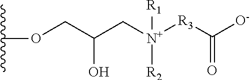
wherein R₁ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₂ are —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₃ is —CH₂—, —CH₂CH₂—, —CH₂CH₂CH₂—, —CH₂CH₂CH₂CH₂—, —CH₂CH₂CH₂CH₂CH₂— or —(CH₂)ₙ—; n is an integer from 1 to 20; and [symbol] is the polymer backbone.

16. The zwitterionic composition of claim 1 wherein said one or more zwitterionic moieties have the formula: 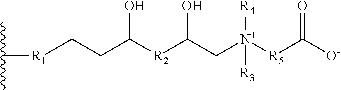
wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂, CH₂CH₂—, —CH₂CH₂CH₂—, —CH₂CH₂CH₂CH₂—, or —(CH₂)ₓ—, R₃ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —CH₂—, —CH₂CH₂—, —CH₂CH₂CH₂—, —CH₂CH₂CH₂CH₂—, —CH₂CH₂CH₂CH₂CH₂— or —(CH₂)_{y}—; m, n, x and y are each an integer from 1 to 20; and [symbol] is the polymer backbone.

17. (canceled)

18. (canceled)

19. The zwitterionic composition of claim 1 wherein at least one of said one or more zwitterionic moieties has a corresponding cationic ring form having a formula selected from: 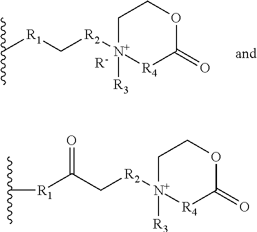
wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂—, —CH₂CH₂—, —CH₂CH₂CH₂—, —CH₂CH₂CH₂CH₂—, —CH₂CH₂CH₂CH₂—, or —(CH₂)ₓ₋₁—; R₃ is —H, —CH₃, —CH₂CH₃, —CH₂CH₂CH₃, —CH₂CH₂CH₂CH₃, CH₂CH₂OH, —CH₂CH₂CH₂OH, —CH₂CH₂CH₂CH₂OH, or —CH₂CH₂CH₂CH₂CH₂OH; R₄ is —CH₂—, —CH₂CH₂—, —CH₂CH₂CH₂—, —CH₂CH₂CH₂CH₂—, —CH₂CH₂CH₂CH₂CH₂—, —(CH₂)_{y}— or —(CH₂)_{y}O(CH₂)_{z}—; R⁻ is any organic or inorganic anion; m, n, x, y and z are each an integer from 1 to 20; and [symbol] is the polymer backbone.

20. The zwitterionic composition of claim 1 wherein at least one of said one or more zwitterionic moieties has a corresponding cationic ring form having the formula: 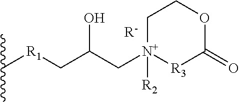
wherein R₁ is —H, —CH₃, —CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₂ is —CH₂—, —CH₂CH₂—, —CH₂CH₂CH₂—, —CH₂CH₂CH₂CH₂—, —CH₂CH₂CH₂CH₂CH₂—, —(CH₂)_{y}— or —(CH₂)_{y}O(CH₂)_{z}—; R⁻ is any organic or inorganic anion; y and z are each an integer from 1 to 20; and [symbol] is the polymer backbone.

21. The zwitterionic composition of claim 1 wherein at least one of said one or more zwitterionic moieties has a corresponding cationic ring form having the formula: 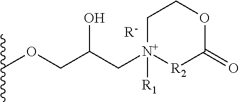
wherein R₁ is —H, —CH₃, —CH₂CH₃, —CH₂CH₂CH₃, —CH₂CH₂CH₂CH₃, —CH₂CH₂OH, —CH₂CH₂CH₂OH, —CH₂CH₂CH₂CH₂OH or —CH₂CH₂CH₂CH₂CH₂OH; R₂ is —CH₂—, —CH₂CH₂—, —CH₂CH₂CH₂—, —CH₂CH₂CH₂CH₂—, —CH₂CH₂CH₂CH₂CH₂—, —(CH₂)_{y}— or —(CH₂)_{y}O(CH₂)_{z}—; R⁻ is any organic or inorganic anion; y and z are each an integer from 1 to 20; and [symbol] is the polymer backbone.

22. The zwitterionic composition of claim 1 wherein at least one of said one or more zwitterionic moieties has a corresponding cationic ring form having the formula: 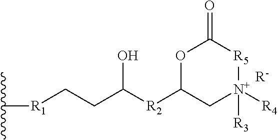
wherein R₁ is —O—, —NH—, —C(O)NH—, —CH₂C(O)NH—, —CH₂CH₂C(O)NH—, —(CH₂)ₘC(O)NH—, —NHC(O)—, —NHC(O)CH₂—, —NHC(O)CH₂CH₂—, —NHC(O)(CH₂)ₘ—, —(CH₂)ₘNHC(O)(CH₂)ₙ—, —(CH₂)ₘNHC(O)O(CH₂)ₙ—, —(CH₂)ₘOC(O)NH(CH₂)ₙ—, —(CH₂)ₘC(O)NH(CH₂)ₙ—, —NHC(O)(CH₂)ₘC(O)NH—, —OC(O)(CH₂)ₘC(O)NH—, —O(CH₂)ₘC(O)NH—, —NHC(O)(CH₂)ₘO—, —NHC(O)(CH₂)ₘC(O)O—, —C(O)O—, —CH₂C(O)O—, —CH₂CH₂C(O)O—, —(CH₂)ₘC(O)O—, OC(O)—, —OC(O)CH₂—, —OC(O)CH₂CH₂—, —OC(O)(CH₂)ₘ—, —OC(O)(CH₂)ₘC(O)O—, —OC(O)(CH₂)ₘO—, —O(CH₂)ₘC(O)O—, —(CH₂)ₘOC(O)(CH₂)ₙ—, —(CH₂)ₘC(O)O(CH₂)ₙ—, —CH₂O—, —CH₂CH₂O—, —CH₂CH₂CH₂O—, —CH₂CH₂CH₂CH₂O—, —CH₂CH₂CH₂CH₂CH₂O—, —CH₂CH₂CH₂CH₂CH₂CH₂O—, —(CH₂)ₘO—, —O(CH₂)ₘO—, —O(CH₂)ₘ—, —(CH₂)ₘ—, —O(CH₂CH₂O)ₘ, —(OCH₂CH₂)ₘ— or —(CH₂CH₂O)ₘ—; R₂ is —CH₂, CH₂CH₂—, —CH₂CH₂CH₂— or —CH₂CH₂CH₂CH₂—; R₃ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₄ is —H, —CH₃, CH₂CH₃, —CH₂CH₂CH₃, —CH₂CH₂CH₂CH₃, —CH₂CH₂OH, —CH₂CH₂CH₂OH, —CH₂CH₂CH₂CH₂OH, or —CH₂CH₂CH₂CH₂CH₂OH; R₅ is —CH₂—, —CH₂CH₂—, —CH₂CH₂CH₂—, —CH₂CH₂CH₂CH₂—, or —CH₂CH₂CH₂CH₂CH₂—, —(CH₂)_{y}— or —(CH₂)_{y}O(CH₂)_{z}—; m, n, y and z are each an integer from 1 to 20; and [symbol] is the polymer backbone.

23. The zwitterionic composition of claim 1 wherein at least one of said one or more zwitterionic moieties has a cationic ring form having a formula selected from the group consisting of: 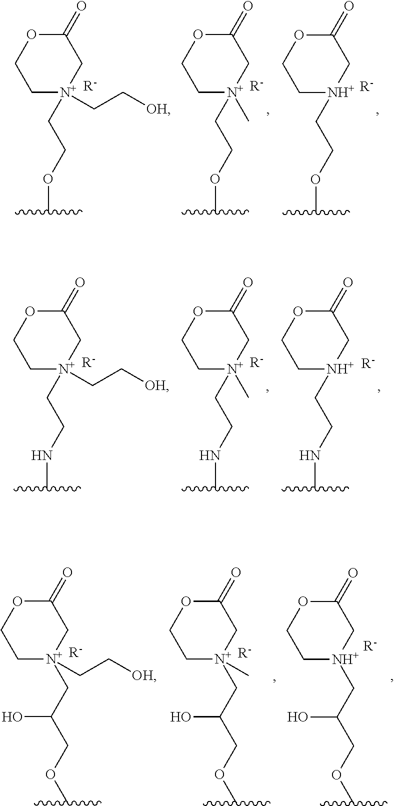 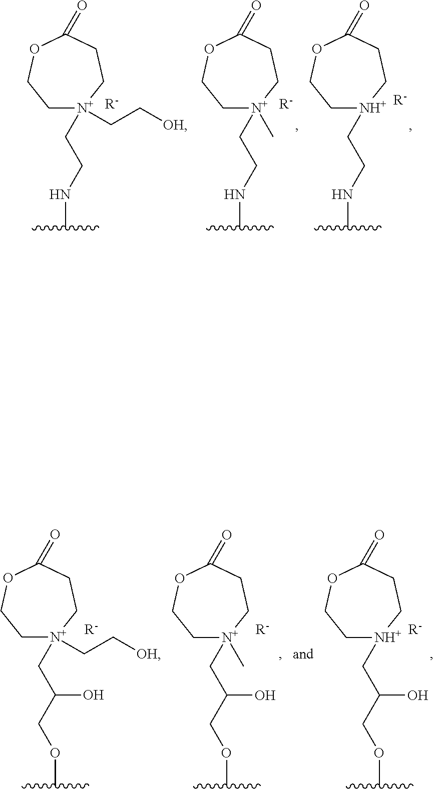
wherein R⁻ is any organic or inorganic anion and [symbol] is the polymer backbone.

24. The zwitterionic composition of claim 1 further comprising one or more methacrylate, acrylate, acrylamide and/or methacrylamide side chains.

25. The zwitterionic composition of claim 24 wherein said one or more methacrylate, acrylate, acrylamide and/or methacrylamide side chains cross link said composition.

26. (canceled)

27. (canceled)

28. The zwitterionic composition of claim 1 further comprising a crosslinking compound.

29. (canceled)

30. The zwitterionic composition of claim 28 wherein said one or more crosslinking compound comprises a compound selected from the group consisting of di(methyl)acrylates, multi-(methyl)acrylates, di(methyl)acrylamides, multi-(methyl)acrylamides, diepoxides, multi-epoxides, dithiols and multi-thiols, and combinations thereof.

31. The zwitterionic composition of claim 28 wherein said one or more crosslinking compound is selected from the group consisting of carboxybetaine di(methyl)acrylate, carboxybetaine di(methyl)acrylamide, poly(ethylene glycol) di(methyl)acrylate, 1,3-propanedithiol, 1,4-butanedithiol, 1,3-butadiene diepoxide, and combinations and/or analogs thereof.

32. A method for forming the zwitterionic polymer composition of claim 1 comprising:
A. preparing a polymer chain with hydroxyl and/or amine groups available for bonding;
B. reacting said polymer chain with zwitterionic betaine carrying one primary amine, secondary amine or tertiary amine, and a dibromoalkane, dichloroalkane, diepoxide, epichlorohydrin, molecule having an acyl halide at a first end and a halide at a second end, molecule having two acyl halide at different ends, multi halide substituted alkane, multi epoxide substituted alkane, multi halide and epoxide substituted alkane or combination thereof in the presence of an organic or inorganic base to produce a zwitterionic polymer composition.

33. The method for forming a zwitterionic composition of claim 32 wherein step B comprises reacting said polymer chain with an ester derivative of zwitterionic betaine that contains one primary amine, secondary amine or tertiary amine, and a dibromoalkane, a dichloroalkane, a diepoxide, an epichlorohydrin, a molecule with an acyl halide at a first end and a halide on a second end, a molecule having two acyl halide at different ends, a multi halide substituted alkane, a multi epoxide substituted alkanes or a multi halide and epoxide substituted alkane to produce a cationic polymer composition; and further comprising:
C. hydrolyzing said cationic polymer in acidic or basic conditions to produce a zwitterionic polymer composition.

34. The method for forming a zwitterionic composition of claim 32 wherein said polymer chain comprises a polysaccharide polymer chain.

35. (canceled)

36. The method for forming a zwitterionic composition of claim 32 wherein step B comprises reacting said polymer chain with dimethylglycine and epichlorohydrin in the presence of an organic and inorganic base to produce a zwitterionic polysaccharide composition.

37. The method for forming a zwitterionic polymer composition of claim 32 wherein step B comprises reacting said polymer chain with 3-bromopropanoyl bromide or 2-bromoacetyl bromide, and zwitterionic betaine carrying a tertiary amine in the presence of an organic and inorganic base to produce a zwitterionic polysaccharide composition.

38. The method for forming a zwitterionic polymer composition of claim 32 wherein step B comprises reacting said polymer chain with 3-bromopropanoyl bromide or 2-bromoacetyl bromide and ester derivative of zwitterionic betaine carrying a tertiary amine in the presence of an organic and inorganic base to produce a cationic polymer composition; and further comprising:
D. hydrolyzing said cationic polymer composition in acidic or basic conditions to produce a zwitterionic polymer composition.

39. (canceled)

40. (canceled)

41. (canceled)

42. The method for forming the zwitterionic polymer composition of claim 32 further comprising:
E. adding methacrylate crosslinking groups to the product of step B by treatment with glycidyl methacrylate.

43. (canceled)

44. (canceled)

45. (canceled)

46. The method for forming the zwitterionic polymer composition of claim 32 wherein said zwitterionic betaine is selected from the group consisting of 2-(di(methyl)(methylene)ammonio)acetate, 2-((methyl)(methylene)ammonio)acetate, 2-((methylene)ammonio)acetate 2-(bis(2-hydroxyethyl)(methylene)ammonio)acetate, 2-((2-hydroxyethyl)(methylene)(methyl)ammonio)acetate, 2-((2-hydroxyethyl)(methylene)ammonio)acetate, 3-((methyl)(methylene)ammonio) propanoate, 3-(bi(methyl)(methylene)ammonio) propanoate, 3-(bis(2-hydroxyethyl)(methylene)ammonio) propanoate, 3-((2-hydroxyethyl)(methylene)(methyl)ammonio) propanoate, 3-((2-hydroxyethyl)(methylene)ammonio) propanoate, and combinations and analogs/derivatives thereof.

47. The method for forming a zwitterionic polymer composition of claim 32 wherein said zwitterionic betaine is selected from the group consisting of 2-(di(methyl)(methylene)ammonio)acetate, 2-((methyl)(methylene)ammonio)acetate, 2-((methylene)ammonio)acetate 2-(bis(2-hydroxyethyl)(methylene)ammonio)acetate, 2-((2-hydroxyethyl)(methylene)(methyl)ammonio)acetate, 2-((2-hydroxyethyl)(methylene)ammonio)acetate, 3-((methyl)(methylene)ammonio) propanoate, 3-(bi(methyl)(methylene)ammonio) propanoate, 3-(bis(2-hydroxyethyl)(methylene)ammonio) propanoate, 3-((2-hydroxyethyl)(methylene)(methyl)ammonio) propanoate, 3-((2-hydroxyethyl)(methylene)ammonio) propanoate, and combinations and analogs/derivatives thereof.

48. (canceled)
